(19) United States
(12) Patent Application Publication
(10) Pub. No.: US 2022/0036306 A1
(43) Pub. Date: Feb. 3, 2022

(54) METHODS AND APPARATUS FOR USING CONFIGURABLE TEMPLATES AND POLICY INFORMATION TO CONTROL USE OF STORAGE LOCATIONS

(71) Applicant: 6 River Systems, LLC, Waltham, MA (US)

(72) Inventors: Matthew Gabeler-Lee, Arlington, MA (US); Elizabeth Clark, Watertown, MA (US)

(21) Appl. No.: 17/065,353

(22) Filed: Oct. 7, 2020

Related U.S. Application Data
(60) Provisional application No. 63/059,725, filed on Jul. 31, 2020.

(51) Int. Cl. G06Q 10/08; G05D 1/02

(52) U.S. Cl. CPC G06Q 10/0875; G05D 1/028; G05D 1/0212

(57) ABSTRACT

Flexible methods and apparatus for automatically assigning storage locations as part of an inventory allocation request satisfaction process are described. In various embodiments inventory allocation request processing templates are used to facilitate the allocation of storage locations to satisfy one or more lines of an inventory allocation request. A client, which sends assignment resource allocation requests, can specify storage allocation constraints and/or preferences in a template. The template corresponding to the client is retrieved and the policy or constraints in the template are applied as part of the storage location assignment process. Clients can easily make changes to their templates allowing for customization of storage location assignments without the need for a detailed understanding of the physical layout of a storage site such as a warehouse. Custom inventory allocation request processing templates can be easily created by a customer modifying a default template to create a custom template.

### RELATED APPLICATIONS

The present application claims the benefit of U.S. Provisional Patent Application Ser. No. 63/059,725 filed on Jul. 31, 2020 which is hereby expressly incorporated by reference in its entirety.

### FIELD

The present application relates to utilization of storage locations and, more particularly, to allocation of storage locations to fulfill an inventory allocation request where the inventory allocation request may be a request that items be supplied, e.g., from a warehouse to satisfy a purchase order, or a request to place items into storage, e.g., a stocking or replenishment order.

### BACKGROUND

Warehouses store a large number of items often referred to as products. In many cases a particular product may be stored at multiple different locations in an individual warehouse. The placement of items in a warehouse for storage, e.g., as part of a stocking or replenishment order or operation and the locations from which items for a particular purchase order are picked can have a significant impact on the operating efficiency in terms of the time required to complete an order. In order to complete a stocking or pick operation to satisfy an order, an inventory allocation request is normally made and in response a set of storage locations to be used in servicing the order is provided.

A number of factors can go into what locations in a warehouse are used to store particular items from where the items are picked. Warehouses must plan inventory work (i.e. “picking” to satisfy purchase orders and also “putaway”/“replenishment” for goods which are received). This often involves allocating individual items, i.e., products, to one or more locations, e.g., a particular location (bin) in the warehouse. Similarly, retail locations also operate with inventory like mini-warehouses, with online orders being received (picking required for customer pick-up in-store) and inventory to be restocked from the backroom to the retail shelves as it is received from warehouses. Inventory of the same product can be stored in multiple locations in the warehouse.

Typically warehouses do the allocation of product, sometimes referred to as inventory, to storage locations well before products are actually received for storage. Such allocations of items to storage locations, performed in response to an inventory allocation request, may not take into consideration many time varying factors including the picking of items from storage locations, identification of inventory errors and/or the presence of damaged items which may reduce the number of units available at a given storage location or the amount of space available for storing additional items at a particular storage location. In some instances, an item may not be found at its intended location, be out of stock, be damaged, have an unscannable barcode, etc. In other instances, the container may be too full with other items, may be too small for a particular item, may need to be batched with other containers (e.g., from another warehouse floor) to complete an order, etc. These instances may be referred to as “exceptions” and can create challenges to efficiently fulfilling a customer order.

Storage location allocation might seem like a simple task for a warehouse manager. However, depending on the time an order is to be satisfied, the system or entity which is sending an inventory allocation request to satisfy an order, and/or current storage location conditions, the allocation of storage locations to satisfy portions, e.g., lines of an inventory allocation request, can be a complicated task. In addition to available capacity or current number of items stored at a location, there can be a large number of factors and/or conditions that could, and often should, be taken into consideration when determining which storage location to use to satisfy a particular inventory allocation request. This is often true whether the inventory allocation request is an inventory allocation request associated with storing products as part of a stocking or restocking operation or the inventory allocation request is an inventory allocation request for picking one or more items, e.g., to satisfy a product purchase order.

### SUMMARY

While it would be desirable to be able to automate the process of allocating item storage locations in response to inventory allocation requests, rigid allocation schemes are likely to fail to take into consideration many factors which would be desirable to consider when making storage location allocations. Furthermore, a rigid allocation scheme applied to a number of different warehouses or storage sites is unlikely to satisfy the needs of individual warehouses which, even if similar in size, may have very different needs depending on delivery schedules, purchase inventory allocation request processing loads affecting the amount of picking going on, different numbers of picking errors resulting in the need for restocking of items, past use of locations and worker expectations that particular products will be in the same location as in the past, etc.

Flexible methods and apparatus for automatically assigning storage locations as part of an inventory allocation request satisfaction process are described. In various embodiments templates are used to facilitate the allocation of storage locations to satisfy one or more lines of an inventory allocation request. In some embodiments each line of an inventory allocation request corresponds to a line item of an order, e.g., a product purchase order or a stocking order.

In some embodiments, an inventory allocation request is supplied for processing to a management system, e.g., an inventory service system.

The management system may, and sometimes does, serve a number of different clients and/or warehouses. In various embodiments a client is an entity which can make an inventory allocation request. One client might be a Pick Exception Handler responsible for picking items that are to correct an error or other problem with a previous item pick; another client might be a robotic cart Work Assigner, etc.

The inventory allocation request can, and often will, include one or more lines. In some cases each line lists a quantity (e.g., number of units) and identifies an item, e.g., product, being requested to be picked or stored as part of the inventory allocation request. Different types of inventory allocation requests are often supplied by different systems. In some embodiments stocking inventory allocation requests are supplied by a manufacture or stocking system, while purchase order inventory allocation requests including items to be picked are supplied by a merchant or seller system who takes inventory allocation requests from one or more individual customers. Other systems which may be, and sometimes are, the source of inventory allocation requests include pick work allocation systems used to allocate picks, e.g., lists of items to be picked, to mobile robotic carts and/or acceptation handling systems. Such systems may be, and sometimes, are clients of the management system which is responsible for processing received inventory allocation requests and assigning storage locations in response to such requests.

The function of the management system of the invention, in some embodiments, is to generate a list of storage locations, e.g., preferably at an individual warehouse, to satisfy an inventory allocation request. The list of storage locations indicate locations which can be used to satisfy an order, e.g., locations from which products listed in an order can be picked in the case of a purchase order. In the case of a storage order the locations are locations where products listed in the storage order can be stored.

In one or more embodiments the management system receives an inventory allocation request from a client system and then processes the lines of the inventory allocation request to generate an output indicating one or more storage locations to be used to satisfy the processed lines of the inventory allocation request. Each line of the inventory allocation request indicates a number of products and an identifier of the product to which the line relates.

In this way the management system can, and sometimes does, specify the storage location or locations where the product identified on the processed inventory allocation request line is to be placed or picked from.

In order to provide for a highly flexible client oriented system an initial or default set of one or more inventory allocation templates are provided. A client is allowed to associate a product with a default template and/or is given the opportunity to revise/modify a default inventory allocation template. In revising a default template the client can revise/modify the default template to client specific mandatory constraints which are to be satisfied and/or client specific preferences to be taken into consideration when performing an allocation. A client can generate different custom templates based on the type of allocation request being made, the time the request is to be implemented, the warehouse where the request is to be satisfied and/or other constraints. Examples of other constraints include a portion of a requested item quantity to be satisfied by a storage location for the location to be considered being used, e.g., in response to an order involving picking items, and/or some other constraint such as that the location be capable of holding a certain number or percentage of items to which a particular template applies in the case of a storage request related template. The time referred to here can be, and sometimes is, expressed relative to a particular period of time such as a holiday and/or non-holiday period. Alternatively a fixed time period can be expressed as a day/time or date range for which a particular template is to be applicable. This allows for a client to provide different templates for different time periods. It should be appreciated that warehouse conditions can vary based on date/time with a warehouse being subject to busy/slow/seasonal conditions for different times, e.g., days of the year and/or hours of the day.

When a request is received, the management system selects, e.g., retrieves from memory, the template or templates to be used to satisfy the request. This normally involves the management system selecting one template to be used for making the location assignment(s) for each line of the request where each line normally corresponds to a different product. Factors used in selecting the template include the client making the request, the time the operation associated with the request (pick or storage) is to be implemented and/or other factors such as the clients express preference to reuse previous locations used to stock an item and/or achieve a particular fill level in a storage location before or after the pick or placement operation associated with the request is implemented.

In various embodiments the templates are implemented using a text-based object notation with, in some cases, the templates being implemented using easily modified JSON objects. While an initial default set of templates can be provided, individual clients can readily and easily modify templates to generate and maintain a custom set of templates which will be used in satisfying requests corresponding to the individual clients.

In this way, different clients' needs and preferences can be easily supported and satisfied.

While various features have been discussed in the above summary, not all features mentioned need be used in all embodiments. Numerous variations on the above described methods and apparatus are possible and are discussed in the detailed description which follows.

### BRIEF DESCRIPTION OF THE FIGURES

FIG. 1 illustrates an exemplary system implemented in accordance with the invention in which inventory allocation requests are processed based on templates which can be, and in some embodiments are, customized by individual clients, e.g., users of the system.

FIG. 2 illustrates exemplary inventory allocation requests corresponding to a variety of different clients which can be, and sometimes are, processed by the system of FIG. 1.

FIG. 3 illustrates additional exemplary inventory allocation requests corresponding to a variety of different clients which can be, and sometimes are, processed by the system of FIG. 1.

FIG. 4 illustrates exemplary templates corresponding to a client, e.g., merchant 1, corresponding to pick order inventory allocation requests corresponding to a first storage site, e.g., a first warehouse, with each template corresponding to a different product SKU.

FIG. 5 illustrates exemplary templates for the client, e.g., merchant 1, corresponding to pick order inventory allocation requests corresponding to a second storage site, e.g., a second warehouse, with the template corresponding to the same products SKUs as shown in FIG. 4 but with different constraints specified.

FIG. 6 illustrates exemplary templates corresponding to another client, e.g., merchant 2, corresponding to pick order inventory allocation requests corresponding to the same product SKUs as shown in FIGS. 4 and 5 but with the template being applicable to a particular time period, i.e., a non-holiday time period.

FIG. 7 illustrates exemplary templates corresponding to merchant 2, corresponding to pick order inventory allocation requests but with the templates being applicable to requests which are made during a holiday time period to which the templates of FIG. 6 do not apply.

FIG. 8 illustrates exemplary templates which are used for a client, e.g., an exception handling system and which include constraints and time information specified by the exception handling system.

FIG. 9 illustrates exemplary templates which are used for a client, e.g., a first product supplier and which include constraints and time information specified by the product supplier with the time for the template to be used relating to a supplier relevant time period, e.g., a scheduled product delivery time.

FIG. 10 illustrates exemplary templates which are used for a client, e.g., a restocking system and which include constraints, e.g., space available constraints, and time information specified by the restocking system.

FIG. 11A illustrates the steps of a first part of a flow chart showing the steps of an exemplary method implemented in accordance with the invention.

FIG. 11B illustrates the steps of a second part of a flow chart showing the steps of the exemplary method implemented in accordance with the invention.

FIG. 11 is a diagram illustrating how FIGS. 11A and 11B are to be combined to create a single flow chart showing the steps of the exemplary method of using the system of FIG. 1 to process and respond to inventory allocation requests in accordance with the invention.

FIG. 12 is an exemplary functional diagram showing management system processing of an inventory allocation request corresponding to an order in accordance with one exemplary embodiment.

FIG. 13 illustrates an exemplary set of default templates.

FIG. 14 is a diagram of a system in which the management system of FIG. 1 is implemented as part of an e-commerce platform which provides merchant products and services to customers, and exemplary systems, websites, devices, providers, applications and channels which interact with the e-commerce platform/management system.

FIG. 15 depicts a non-limiting embodiment for a home page of an administrator, which may show information about daily tasks, a store's recent activity, and the next steps a merchant can take to build their business.

### DETAILED DESCRIPTION

Methods and apparatus for providing flexibility in terms of automating the allocation of storage locations when trying to satisfy inventory allocation requests relating to the storage or pick of one or more items are described. In various embodiments the allocation of storage locations takes into consideration a wide range of factors and/or conditions including policy considerations that may be applicable to one storage site but not to another.

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

Various embodiments allow different clients, e.g., systems, parties, entities, and/or individuals, to influence the storage location allocation process based on their particular needs at a given time. The methods and apparatus of the invention allow a system or entity providing an inventory allocation request for processing to have at least some control over the storage location allocation process with the control, in at least some cases, being at a relatively granular level. The level of control can be, and in some embodiments is, even down to the level at which storage locations are assigned to satisfy an individual inventory allocation request corresponding to an order line, e.g., storage of one or more items of a particular item listed on a line of an order.

In at least some embodiments the ability to influence how inventory allocation requests are satisfied is provided to a client or client system without requiring the client exerting the control over the storage location allocation process needing detailed knowledge of how the allocation system works. In various embodiments a client has the ability to add to, modify, or revise one or more default allocation rules or policies without having to independently generate a complete set of rules or policies for each product to be stored or retrieved.

The methods and apparatus provide a client a controllable, flexible and/or dynamic system that can make inventory to storage location allocation decisions in an automated manner, e.g., based on client customizable templates. As will be discussed in detail below, in at least some embodiments the allocations are performed on a per-line-item basis, per warehouse basis, and/or per SKU basis.

The assignment of storage locations can be, and sometimes is, tailored to plan work based on the condition of the system implementing a storage or pick based on the actual or expected state of the system at a client specified time, e.g., at a future time at which the storage locations assigned in response to a storage allocation request are to be used, e.g., for storage of one or more items.

By using customizable templates, which can be easily configured by an individual client, various features relate to the problem of how to provide clients a large degree of control over allocation and storage spaces in a warehouse or other facility, without the client needing detailed knowledge of the facility and/or system used to respond to storage allocation requests.

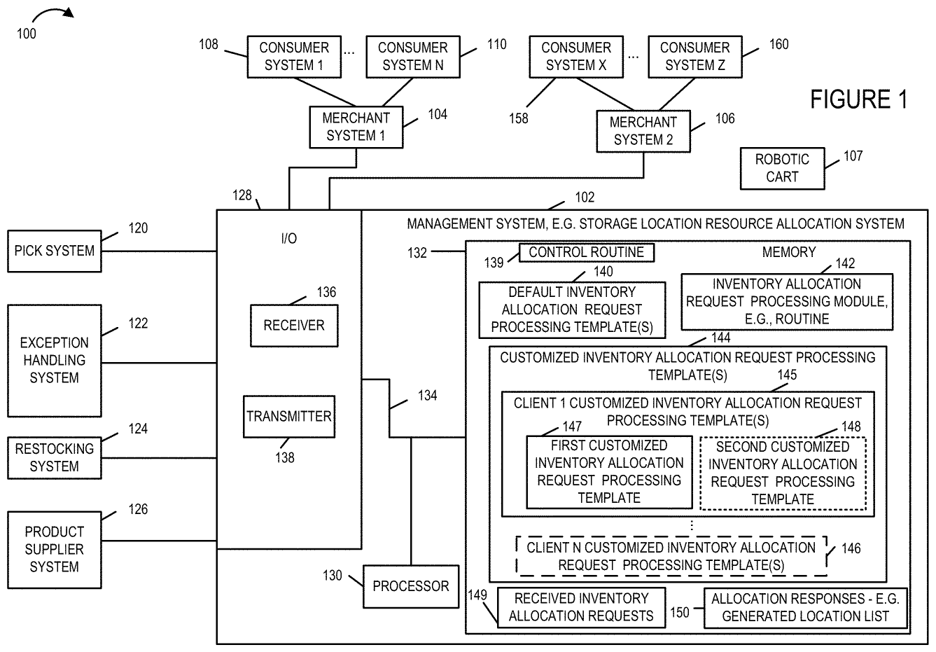

FIG. 1 illustrates an exemplary system 100 implemented in accordance with the invention in which inventory allocation requests are processed based on templates which can be, and in some embodiments are, customized by individual clients, e.g., users of the system. The system 100 includes consumer systems (consumer system 1 108, . . . , consumer system N 110) which are coupled to merchant system 104. Consumer systems 108, 110 may be, and sometimes are, cell phones and/or computers corresponding to individuals who may, and sometimes do, order products from merchant 1 via merchant 1 system 104 which may be and sometimes is a computer based web site or server. The system 100 also includes consumer systems (consumer system X 158, . . . , consumer system Z 160) may be, and sometimes are, cell phones and/or computers corresponding to individuals who may, and sometimes do, order products from merchant 2 via merchant 2 system 106. Merchant system 106 may be, and sometimes is, a computer based website or server.

Merchant systems 104 and 106 are coupled to, and in electronic communication with, management system 102 via the I/O interface 128 of the management system 102. From the perspective of the management system 102, merchant systems 104 and 106 are client devices which can, and sometimes do, submit inventory allocation requests to the management system 102 for processing. Inventory allocation requests from merchants systems 104, 106 are often in the form of customer orders which list products to be picked from storage and shipped to a consumer, e.g. a customer. Since the merchant systems 104, 106 are coupled to the consumer devices 108, 110, 158, 160 they can accept orders for items that are stored at one or more warehouses and pass the orders as requests to the management system 102 for fulfillment, e.g., item picking and shipment of the picked items to the customer which ordered them.

In addition to the merchants systems 104, 106 the management system is also coupled via its I/O interface 128 to various other systems which appear as clients to the management system. In FIG. 1 a pick system 120, exception handling system 122, restocking system 124 and product supplier system 126 are shown coupled to the management system 102.

The pick system 120 is a system responsible for assigning item pick tasks to robotic carts and/or workers as part of an order satisfaction process. The pick system 120 may, and sometimes does, submit a pick order to the management system 102. The pick order may, and sometimes does, correspond to a customer order communicated from a merchant system 104, 106 where the customer order may have been communicated via the management system 102 or directly to the pick system 120. Alternatively the management system 102 may receive the customer order and then communicate with the pick system 120 with regard to the need to assign robotic carts to pick items for one or more customer orders.

Exception handling system 122 is a system that deals with various pick or storage related problems. For example when the pick system 120 fails to find items at expected storage locations the pick for an order may be incomplete. The item missing from the order can be, and sometimes is, considered an exception since it needs to be picked to complete the order and was not included with the initial order pick as was expected. The need for an item or a few items to complete an order is often communicated to the exception handling system 122, e.g., from the pick system 120 or another system. Thus it should be appreciated that the exception handling system 122 is responsible, at least in some cases, for initiating picking of items to complete an order. In many cases storage allocation requests sent by the exception handling system 122 are considered to relate to high priority picks because they are often being used to complete a partially completed order which can not be shipped until the exceptions are dealt with, e.g., the missing order items are picked and added to the other items collected for a customer order.

Restocking system 124 may, and sometimes does, deal with the need to restock, e.g., place mis-picked items, back into storage locations. Restocking can also relate to reloading of partially depleted storage locations. The restocking system 124 can send storage allocation requests to the management system 102 to determine locations where a few or small number of items should be placed into storage as part of a restocking operation; however, the actual number of items that can be handled by the restocking system 124 is not limited to a few or small number of items and can in fact involve large numbers of items depending on the circumstances.

Product supplier system 126 may be, and sometimes is, a manufacturer or shipper system responsible in many cases for supplying truckloads of items to be stored in a warehouse. The product supplier system 126 can, and sometimes does, send storage location allocation requests to the management system 102 so that items that are being delivered in large quantities, e.g., by the truck load, can be stored to support future pick operations.

Management system 102 includes in its input/output (I/O) interface 128 both a receiver 136 and transmitter 138 allowing the management system 102 to receive resource allocation requests and communicate storage location information back to the requesting devices or devices involved in order satisfaction about the storage locations which should be used in response to the storage location allocation requests. In cases relating to requests for locations to store items, e.g., as part of a stocking or restocking operation, the management system 102 normally assigns spaces in a warehouse for particular products to be placed, e.g., stored. In the case of order related requests, the management system 102 normally specifies locations from which items in an order or exception handling request are to be obtained, e.g., picked.

The management system 102 includes a processor 130 and memory 132 coupled to the I/O interface 128 via bus 134. Under control of the processor 130 which controls operation of the management system 102, storage allocation requests can be received, processed and storage allocation responses communicated to one or more devices, e.g., the system from which the request was received and/or the system, e.g., pick system 120 or restocking system 124, used in satisfying a particular allocation request.

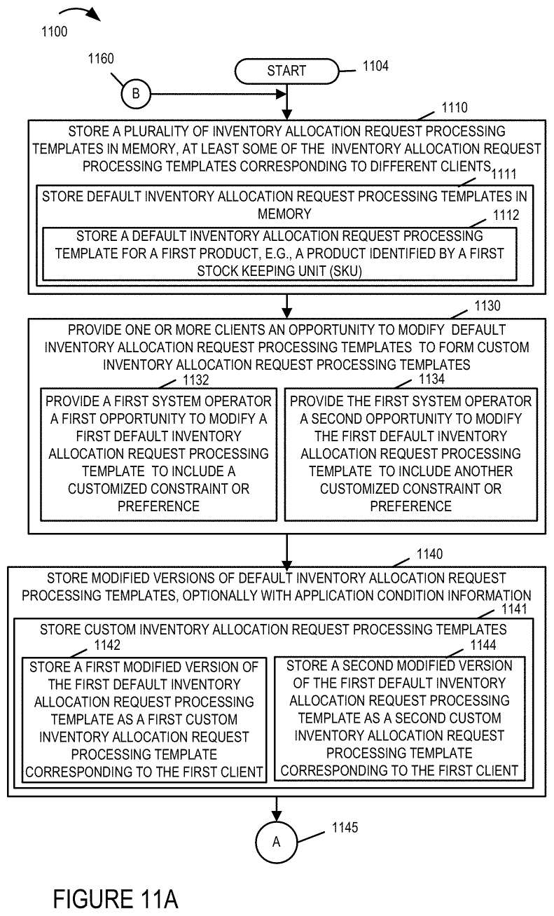

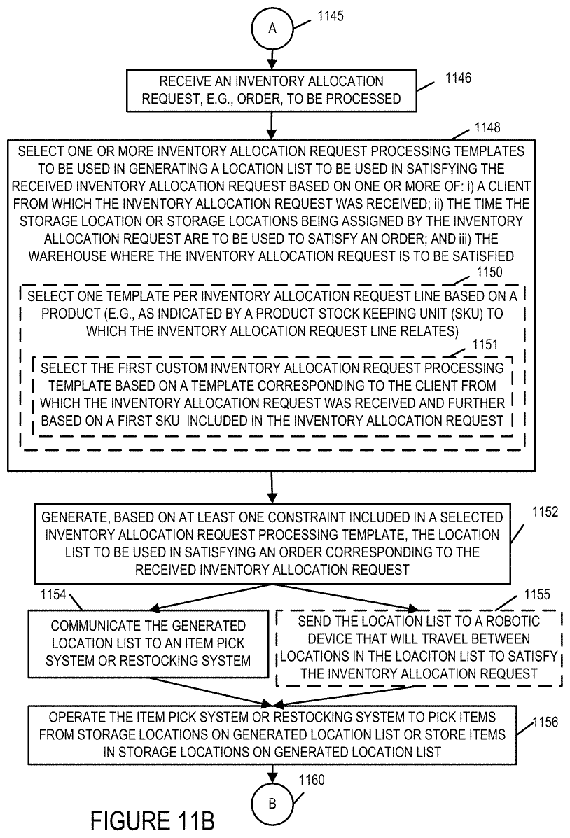

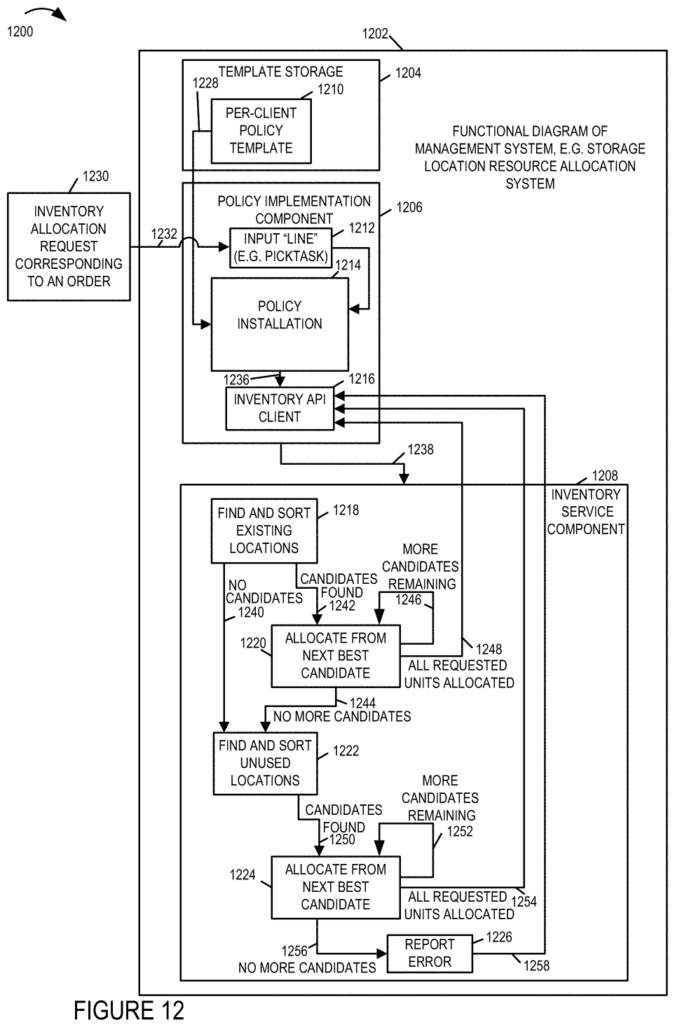

The memory 132 includes a control routine 139 and an inventory allocation request processing module, e.g., routine, 142, which when executed by the processor 130 causes the management system 102 to operate in accordance with the invention. The inventory allocation request processing module 142 handles processing of inventory allocation requests, e.g., using templates in accordance with the present invention. Such operation will be discussed further with regard to the flow chart of FIG. 11 and the functional diagram shown in FIG. 12 which will be discussed further below.

In addition to the control routine 139, the memory 132 includes a variety of inventory allocation templates including default inventory allocation request processing templates 140, customized inventory allocation request processing templates 144. The default inventory allocation templates 140 include default request processing constraints and/or rules, e.g., set by warehouse management, to be used for items for which customers have not provided customized templates. Customized inventory allocation request processing templates 144 include sets corresponding to different customers. Template set 145 corresponds to a first client and includes first customized inventory allocation request processing template 147 and second customized inventory allocation request processing template 148. Template sets are provided for multiple different customers as represented by the ellipsis ( . . . ) extending between the first set of customized templates corresponding to client 1 145 and the Nth set of customized inventory allocation request processing templates 146. Each system 104, 106, 120, 122, 124, 126 which can send an inventory allocation request to the management system can, and sometimes does, have its own set of custom inventory processing templates stored in the set of templates 144.

In addition to storing templates, the memory 132 is used to store received inventory allocation requests 149 and the results 150 of processing the inventory allocation request, e.g., a generated list of storage locations to be used for picking or storing items depending on the type of request that was received.

Management system 102 is in wired or wireless communication with one or more robotic carts 107 which are used to travel between storage locations and transport items to be picked or stored. In various embodiments the management system sends a storage location list corresponding to an order to be picked or items to be stored to a robotic cart 107 which then travels between the locations to complete the pick or storage operation(s) associated with an order. A human worker may and sometimes does accompany the robotic cart 107. However in some embodiments the robotic cart 107 may, additionally or alternatively, include a robotic pick arm which automatically transfers at least some items to be stored from pick storage locations on the location list provided to the robotic cart or stored items in the storage locations on the list of locations provided to the robotic cart in the case of a stocking or restocking order.

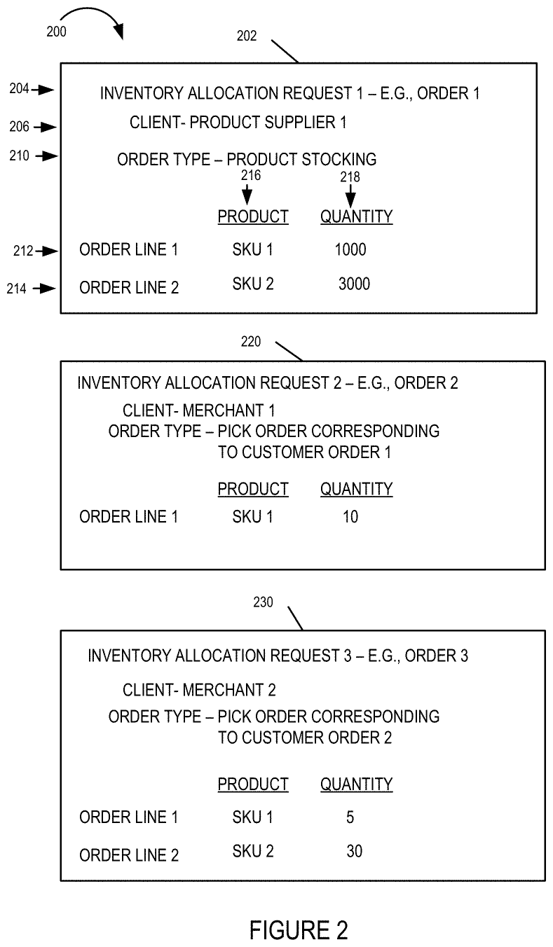

FIG. 2 illustrates exemplary inventory allocation requests 200 corresponding to a variety of different clients which can be, and sometimes are, processed by the management system 102 of FIG. 1. Each of the inventory allocation requests 202, 220, 230 corresponds to a customer order in the FIG. 2 example. The requests are indicated to be orders, but the orders can be stocking type orders requesting allocation of storage locations to stock items or pick orders requesting allocation of storage locations from which previously stored items are to be picked.

Exemplary inventory allocation request 202 includes in the first row 204 is used to identify the inventory allocation request, e.g. using a number such as 1, e.g., Request 1. The requests may be and sometimes are sequentially numbered as they are sent from an individual system. The second row 206 of the inventory allocation request 202 provides information on the client which sent the request 202 to the management system 102. In the case of request 202 the client is a product supplier, product supplier 1, e.g., who operates product supplier system 126 and sends the request 202 from product supplier system 126 to management system 102. In the case of request 202, row 3 210 of the indicates the particular type of request, e.g., a product stocking order. Request 202 is a product stocking request order. The request 202 may be, and sometimes does, correspond to a truck load of products which the product supplier, e.g., a shipper or manufacturer, will ship to a warehouse for storage. Given that the request 202 is for a product stocking order, the management system 102 knows that the allocation request 202 is a request to find storage locations to store the items listed in the order in the indicated quantities. Product, i.e., item identification information in the form of product SKUs is included in column 216. Quantity information, e.g., the number of items identified by the product SKY in column 216, is included in column 218.

Order lines 212, 214 include information relating to individual products. The first order line 212 indicates that it relates to items identified by SKU 1 and that the quantity associated with the order is 1000. The second order line 214 relates to items identified by SKU 2 and the indicated quantity is 3000. From the fact that the order 202 is a stocking order and based on the product and quantity information included in order line 1 212 and order line 2 214, the management system 102 knows that it will have to allocate sufficient storage locations to store 1000 of the items identified by product SKU 1 and 3000 items identified by product SKU 2. The size and shape of the items can be, and sometimes is, determined by the system 102 from information in memory and/or which is accessed via the I/O interface 128. The information included in the inventory allocation requests can be and sometimes is used to identify which inventory allocation request processing template to use in processing the request. As will be discussed below a custom inventory allocation request processing template will be used to process a received inventory allocation request but if there is no custom template with fields, e.g., client, warehouse location, order type, and/or product SKU matching the fields of the inventory allocation request a default processing template may and sometimes will be used to process a received inventory allocation request.

The shipment to which order 202 relates may be, and sometimes is, a truck or rail shipment of items to a warehouse. Such items may be, and sometimes are, arranged on a truck in pallet or box size quantities which can be placed into storage as a unit assuming sufficient space is available. Accordingly when allocating storage locations for such large shipments it can be useful to have storage locations completely empty and of a sufficient size so that a full pallet or group of boxes can be stored at once. A shipper, with knowledge of how the items were packed for shipment on the trunk or train car used to deliver the items, can use a template, also sometimes referred to as an inventory allocation request processing template, in accordance with the invention, as discussed below to influence the assignment of storage locations which will be used to store the items in the shipment to which the order 202 relates.

The second 220 and third 230 inventory allocation requests shown in FIG. 2 include similar information to that of the first inventory allocation request 202 but relate to pick orders corresponding to different merchants as opposed to a stocking order. The second inventory allocation request 220 corresponds to an order, a pick order corresponding to a customer order, sent by merchant 1 to the management system 102. The pick order may be, and sometimes is, communicated from merchant system 1 104 to I/O interface 128 for processing. The pick order 220 relates to an order for merchandise placed by a first customer and is indicated to be customer order 1. Order line 1 indicates that the order is for a quantity of 10 items identified by product SKU 1. Merchant 1 can influence the assignment of storage locations from which the 10 items are to be picked using an inventory allocation request processing template as will be discussed further below.

The third inventory allocation request 230 corresponds to an order, a pick order corresponding to a customer order, sent by merchant 2 to the management system 102. The pick order may be, and sometimes is, communicated from merchant system 1 106 to I/O interface 128 for processing. The pick order 230 relates to an order for merchandise placed by a customer and is indicated to be customer order 2. Order line 1 indicates that the order is for a quantity of 5 items identified by product SKU 1. Order line 2 indicates that the order is also for 30 items identified by product SKU 2. Merchant 2 can influence the assignment of storage locations from which the items are to be picked using templates, separate templates, for items identified by product SKU 1 and by product SKU 2, controlled by Merchant 2 as will be discussed further below. The control of the allocation of storage locations can be used to influence the efficiency of the pick and/or to intentionally empty some storage locations to make the space available for future item shipments.

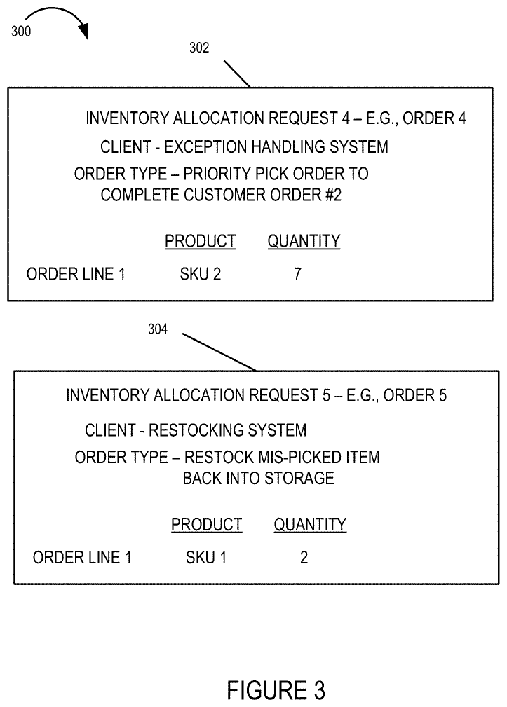

FIG. 3 shows additional examples 300 of inventory allocation requests. The additional inventory allocation requests include fourth inventory allocation request 302 which is from the exception handling system 122. Such requests are often for a relatively low number of items needed to complete an order which was not successfully completed, e.g., because an item was not at the expected storage location or was damaged and thus not picked for shipment. The order 302 is indicated to be a priority pick order relating customer order 2. As indicated on order line 1 it is for 7 items identified by product SKU 2. The exception handling system 122 can influence the time required and likely success of the pick by using a template and condition intended to increase the chance that a picker will be able to successfully obtain the items to which the order 302 relates from a single storage location or a few storage locations and thus allow for order completion in a quick and efficient manner. FIG. 3 also shows a fifth inventory allocation request 304 which corresponds to a restocking system, e.g., restocking system 124. While being a type of stocking order, restocking orders often relate to a relatively small number of items, e.g., items which were mis-picked or which need to be restocked for other reasons. The inventory allocation request 5 304 is a restock of mis-picked items type of order and relates to 2 items identified by product SKU 1. Restocking often relates to individual loose items and not large groups of items packaged together as in a truck shipment. The restocking system 124 can influence the allocation of storage locations into which the items to be restocked are to be placed via use of an inventory allocation request processing template as will be discussed below.

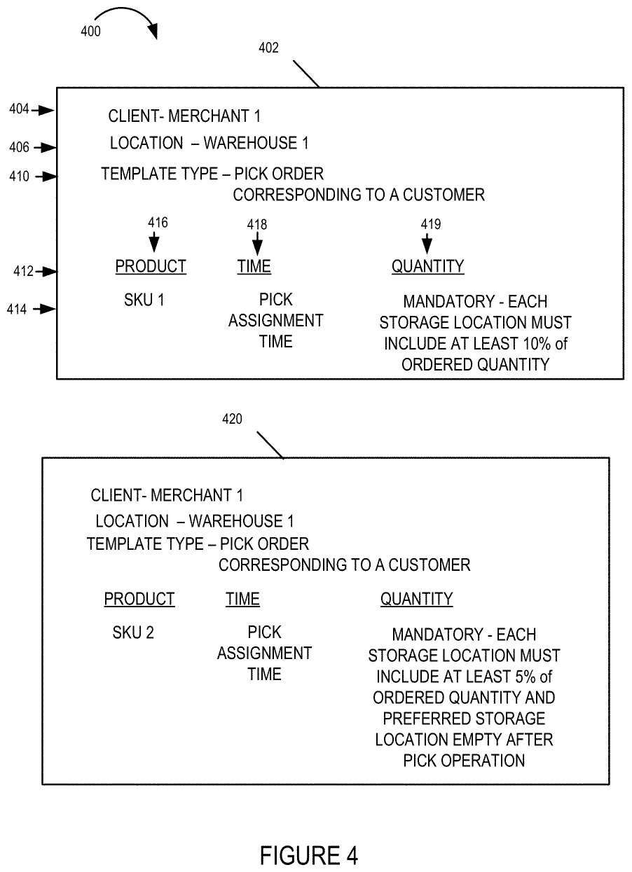

FIG. 4 illustrates a first set 400 of exemplary inventory allocation request processing templates corresponding to a client, e.g., merchant 1. The templates 400, include inventory allocation request templates to be used for pick orders corresponding to a first merchant, merchant 1, that are to be satisfied using storage locations at a first warehouse, warehouse 1. The templates 402, 420 may be, and sometimes are, used as client 1 customized inventory allocation request templates 147, 148 shown in FIG. 1.

The first customized template 402 includes client identification information 404, indicating that the template corresponds to merchant 1, location applicability information 406 indicating that the template 402 is applicable to requests relating to warehouse 1 storage locations, and also includes template type information 410 which indicates that the template relates to a pick order. Templates can be used to specify constraints and/or preferences to be taken into consideration by the management system 102 when allocating storage locations in response to a storage location allocation request to which the template relates. In various embodiments different templates are used for different items and/or warehouses with the client being able to customize the constraints and to which requests from the corresponding client the template is to be applied during the storage location allocation process. Headers in row 412 are used to indicate the type of information included in each row 416, 418, 419 of product related information. Each template includes information identifying a product or products to which the template applied, e.g., in product column 416. Time information is included in time column 418 which can specify a time for which the allocation is to be made, e.g., before, at or after a particular event and/or a time period to which the template is applicable such as a holiday time period or non-holiday time period. The quantity column 419 can be used to specify various quantity related constraints such as a certain portion of an ordered quantity that is to be satisfied by one or more storage locations to be allocated, an amount the storage locations are to be empty after a pick, a total number of items that an allocated storage location should be able to hold or various other constraints. Columns 418 and 419 can be used to specify various constraints and/or preferences which allow the client to which the template corresponds to influence the allocation of storage locations without having to have detailed knowledge of the warehouse or other storage site being used to satisfy submitted storage allocation requests. Row 414 provides information for a single product identified by SKU 1. The information indicates that the template is to be applied at pick assignment time, e.g., when locations are assigned to a pick list to be used to pick items corresponding to an order. The information 414 also indicates a mandatory quantity constraint in column 419, i.e., that each storage location allocated must include at least 10% of an ordered quantity of an order to which the template is being applied. If successfully applied, this will limit the number of storage locations from which products identified by SKU 1 are picked for an order to 10 or fewer locations. By upping the % constraint the merchant can reduce the number of separate locations which will be sued to satisfy the order. In cases of high demand this can be desirable but in cases where the items are distributed in multiple locations, e.g., due to stocking at different times, the merchant may desire to keep this number relatively low.

The second template 420 shown in FIG. 4 is also a customized template corresponding to merchant 1 and relates to requests to be satisfied using warehouse 1. The template is a pick order template for the product identified by SKU 2 and is to be used at pick assignment time. Note that in the second template 420 the constraint relating to quantity is a 5% constraint meaning that each storage location must be able to satisfy 5% of an ordered quantity of the item identified by SKU 2. Thus up to 20 different locations may be used to satisfy a request for item 2 in an order that is processed using template 420.

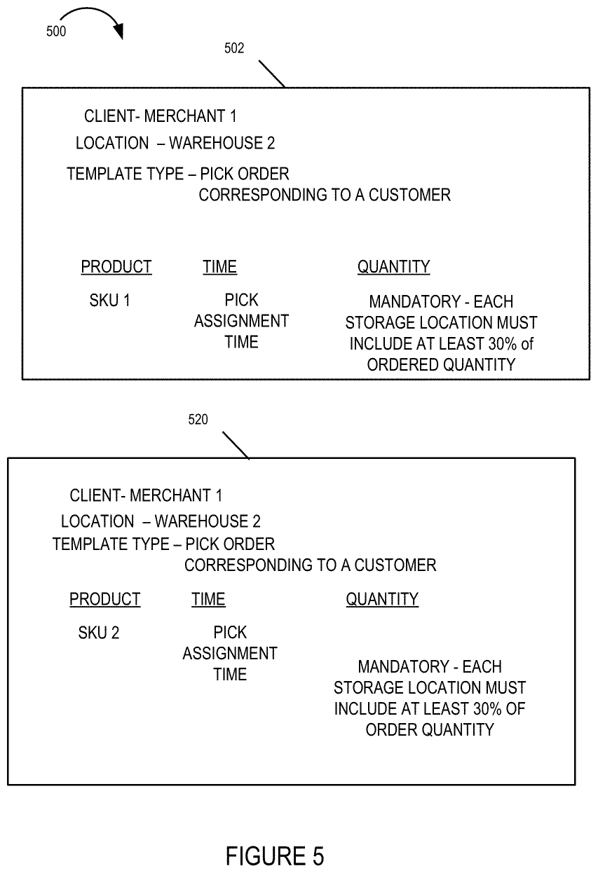

FIG. 5 illustrates a set 500 of exemplary templates 502, 520 for the client, e.g., merchant 1, corresponding to pick order inventory allocation requests corresponding to a second storage site, e.g., a second warehouse identified as warehouse 2, with the template corresponding to the same products SKUs as shown in FIG. 4 but with different constraints specified. FIG. 5 is used to show how a client, such as merchant 1, can specify different constraints for different warehouse locations, e.g., with the constraints in FIG. 5 being different from those shown in FIG. 4. Note that in the FIG. 5 example a 30% quantity satisfaction constraint is specified which may reflect knowledge by the merchant that there are larger numbers of the items stored in individual storage locations at warehouse 2 than warehouse 1 making a higher constraint possible.

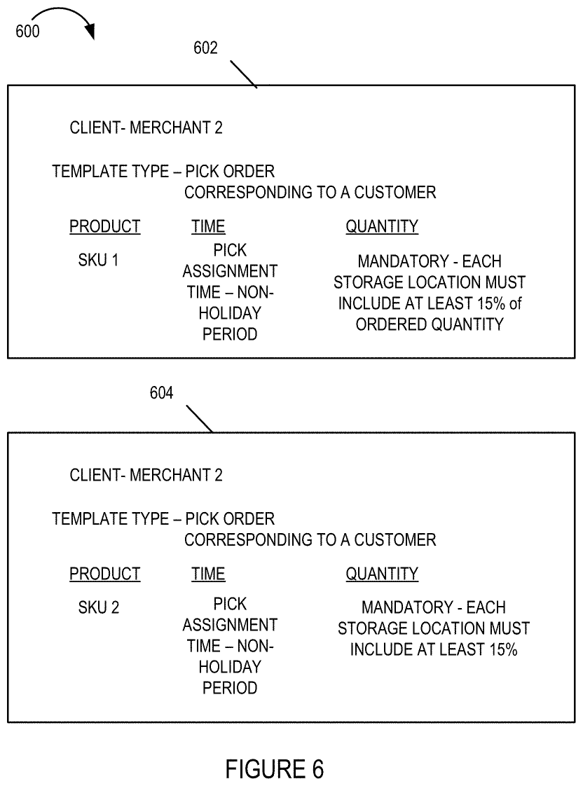

FIG. 6 illustrates a set 600 of exemplary templates 602, 604 corresponding to another client, e.g., merchant 2, corresponding to pick order inventory allocation requests corresponding to the same product SKUs as shown in FIGS. 4 and 5 but with the template being applicable to a particular time period, i.e., a non-holiday time period with the templates to be applied at the time of a pick assignment being made for a pick order corresponding to a customer order. In the FIG. 6 templates 602, 604 a constraint that storage locations allocated in response to a request include at least 15% of the indicated number of items of a particular type specified in an order for the storage location to be assigned as a location that is to be used in response to the allocation request.

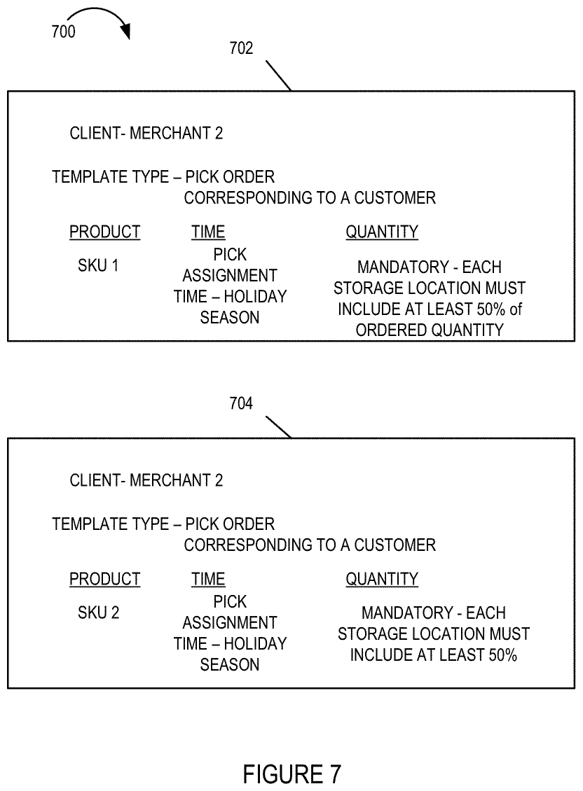

FIG. 7 illustrates exemplary set of templates 700 corresponding to merchant 2, corresponding to pick order inventory allocation requests but for the templates 702, 704 being applicable to request received from the client, e.g. merchant 2, during a holiday time period to which the templates of FIG. 6 do not apply. Note that during the holiday season the merchant may stock a large quality of items in individual storage locations and seek to minimize the number of separate locations a picker has to access to complete in order to reduce order processing time as compared to non-holiday periods. In the FIG. 7 example the mandatory quantity constraint is set to 50% of the ordered quantity to reduce the number of locations which will need to be visited to complete an order as compared to when the 15% non-holiday constraint used in FIG. 6 is applied.

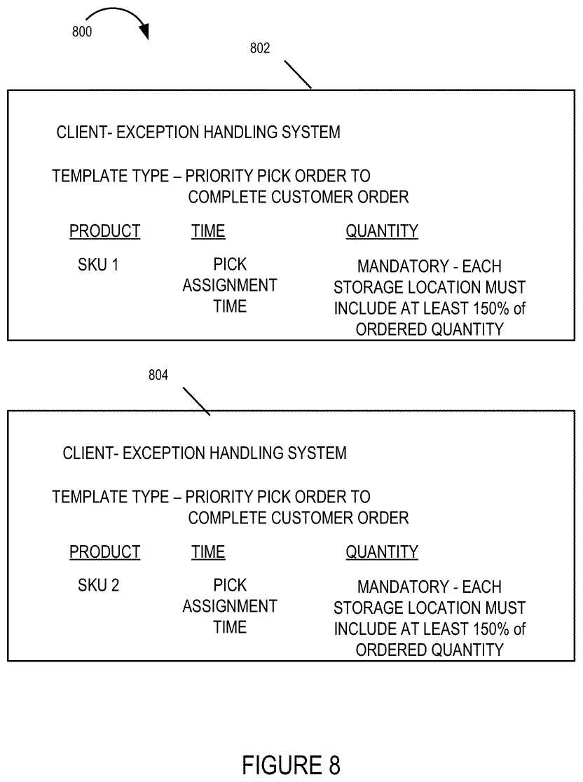

FIG. 8 illustrates an exemplary set of templates 800 which are used for a client, e.g., an exception handling system 122 and which include constraints and time information specified by the exception handling system 122. The exception handling system 122 may, and often will, want to avoid pick failures for high priority orders and want the exception handling related picks to be completed quickly so that partially completed orders can be completed and shipped. To achieve this objective the exception handling system may use custom storage location resource allocation processing templates 802, 804 with mandatory quantity constraints that specify that individual storage locations assigned to service the order should include more than the number of items specified in an order. For example in the FIG. 8 templates 802, 804 the quantity constraint is set so that the assigned storage locations should include 150% of the ordered quantity. This excess of the ordered quantity constraint reduces the risk that the allocated storage location will include less than the required number of items to complete an order, e.g., due to an item miscount or a previous incorrect pick of the time being sought which was not accounted for. For items encountering miscount errors this number can be, and sometimes is, automatically adjusted by the exception handling system 122. Thus the exception handling system 122 can, and sometimes does, track exceptions that occur due to miscounts and then adjusts the quantity percentage upward as the number of miscounts of stored items increases for a particular item. This is easily done by adjusting the quantity constraint information in the template corresponding to an item for which miscounts, e.g., item over counts which indicate more items than are present, are encountered and detected in the form of incomplete orders due to the items in the storage locations being fewer than the inventory count indicates.

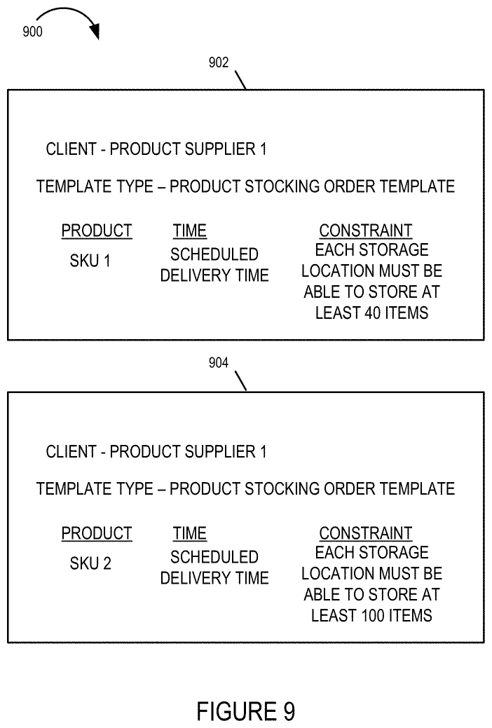

FIG. 9 illustrates a set 900 exemplary templates 902, 904 which are used for a client, e.g., a first product supplier and which include constraints and time information specified by the product supplier with the time for the template to be used relating to a supplier relevant time period, e.g., a scheduled product delivery time. In the case of the product supplier the constraint is indicated in terms of a number of units which should be able to be stored in a single location. While expressed as a fixed number of times this number could also be expressed in terms of a percentage of the overall shipment. By indicating that a number of items are to be stored together, the shipper can take into consideration the way the items are packed for shipment allowing a pallet or other collection of items on a truck to be off loaded and efficiently stored as a unit. In the case of the templates 902, 904 the template is applicable and intended to be used for an allocation of storage locations that are to be available at a scheduled delivery time. The scheduled delivery time may be, and sometimes is, communicated in the storage location allocation request sent from the product supplier system 126 to the management system 102 but might also be communicated separately or based on a fixed periodic delivery schedule. The product supplier, e.g., manufacturer or shipper, can easily update the quantity constraint in the templates 902, 904 if the number of items that are packaged together as a unit for shipment is changed.

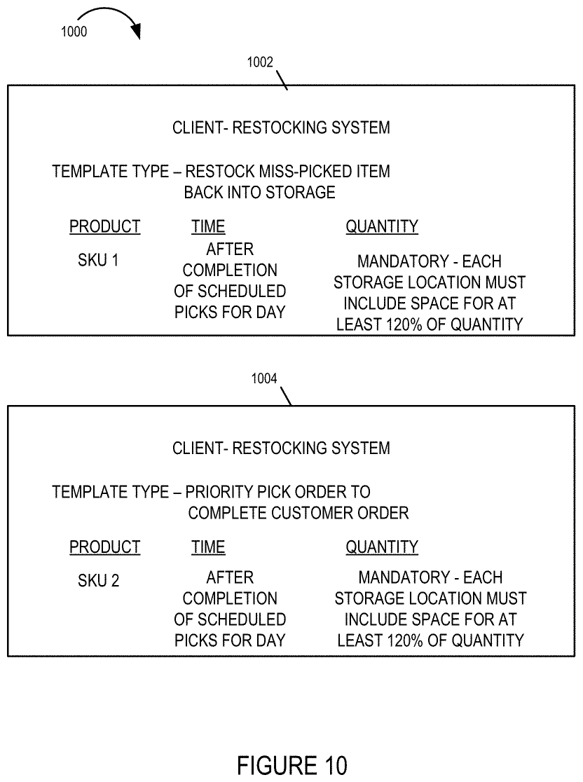

FIG. 10 illustrates a set 1000 exemplary templates 1002, 1004 which are used for a client, e.g., a restocking system 124. The templates 1002, 1004 include constraints, e.g., space available constraints, and time information specified by the restocking system. In the case of restocking, e.g., due to mis-picked items, the number of items to be restocked may be relatively small but is it desirable that adequate space be available for the restocking operation and that it be easy for the item being restocked to be placed in a storage location. Thus in the restocking case it can be desirable to specify a quantity constraint that results in more space than should be required to complete the restocking operation to be available at assigned storage locations. In the FIG. 10 example a 120% space requirement is included as a constraint. Thus there must be space for 120% of the quantity of items specified in an order to which the template is applied for the storage space to be allocated in response to a restocking order. In the FIG. 10 example the templates 1002, 1004 also indicate that the templates are to be used, and the restocking space allocations for items to which the templates apply, after completion of scheduled picks for a day. Thus the restocking can occur after the picks for the day are completed and the empty space available due to such picks taken into consideration by the management system 102.

FIG. 11, which comprises the combination of FIGS. 11A and 11B, illustrates the steps of a flow chart 1100 showing the steps of an exemplary method implemented by the management system 102 in accordance with the invention. The steps of the method 1100 may be, and sometimes are, controlled by the inventory allocation request processing module, e.g., routine, 142 which includes instructions in some embodiment that, when executed by the processor 130 control the system 102 to implement the steps of the method.

The method starts in step 1104, e.g. with management system 102 being powered on and beginning to implement the method under control of the processor 130.

Operation proceeds from start step 1104 to storage step 1110. In storage step 1110 the system 102 stores a plurality of inventory allocation request processing templates in memory. The stored templates can include default templates 140 which may be non-client specific as well as client specific templates 144. The default templates 140 can be edited and customized by individual clients and then stored as client specific templates 144.

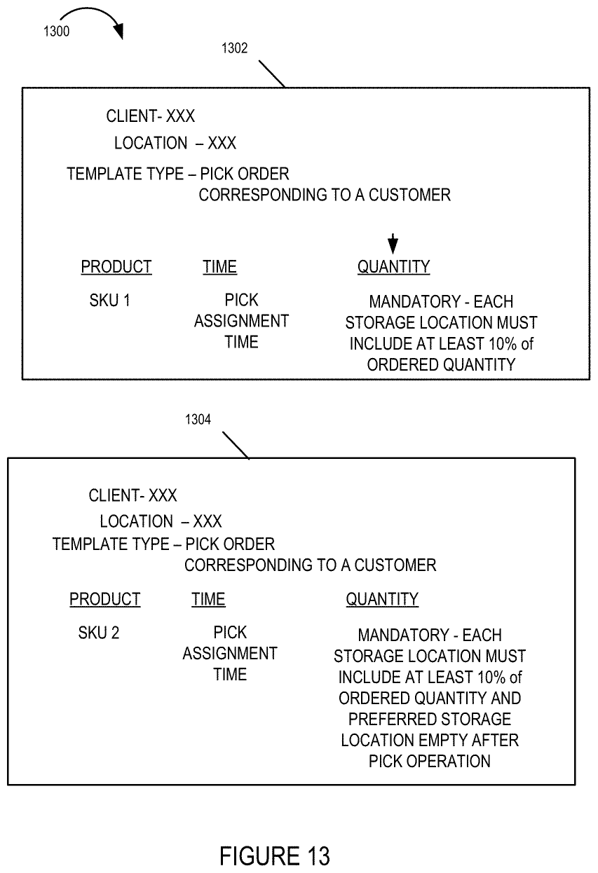

Referring now briefly to FIG. 13 a set 1300 of exemplary default templates 1302, 1304 is shown. Default template 1302 is provided for a first product identified by SKU 1 and default template 1304 is provided for a second product identified by SKU 1. In some embodiments a default template is stored for each product for which a storage or pick request may be received. In the default template XXX is used to indicate a don't care condition. Thus in the FIG. 13 example it should be appreciated that the templates are not restricted to a specific client or warehouse. While these fields are set to don't care values in the default template, they are included in the default template to facilitate easy creation of custom templates from the default templates should a client choose to create a custom template. As will be discussed further below default templates can be accessed and modified to create, through simple editing, client specific templates such as those shown in FIGS. 4 and 5.

The client specific templates 144 can be one or more of the templates shown in FIGS. 4-10. Unedited default templates corresponding, e.g., to a product SKU, are used when a client specific template is unavailable.

Referring once again to FIG. 11, step 1110 includes, in some embodiments steps 1111 and 1112. In step 1111 default inventory allocation request processing templates 140 are stored in memory. Step 1111 includes, in some embodiments step 1112 which involves storing a default inventory allocation request processing template for a first product, e.g., a product identified by a first SKU. The default inventory allocation request processing template stored in step 1112 may be the same as or similar to inventory allocation request processing templates 402 or 502 but without the client identifier and location information in that the default template is not limited to being applied to requests from a particular client or for a particular location.

Operation proceeds from store step 1110 to step 1130 in which one or more clients are provided an opportunity to modify a default inventory allocation request processing template to form customer inventory allocation processing template(s). By making multiple versions of a template, e.g., for different locations or time periods, a client can create a custom set of templates to be used as may be applicable. Step 1130 includes, in some embodiments, providing a first system operator a first opportunity to modify a first default inventory allocation request processing template to include a customized constraint or preference including potentially specifying a time period in which the template is applicable, e.g., holiday time period vs. non-holiday time period. In step 1134 which is part of step 1130 in some embodiments, the first system operator is provided a second opportunity to modify the default inventory allocation request processing template to include another customized constraint or preference. In this way the system operator can construct different customized templates for different time periods, locations or products. While steps 1132 and 1134 result in the generation of two custom templates corresponding to a client, each client can generate multiple custom templates in step 1130 and different clients often generate their own custom step of templates from the default templates that are available. Clients who generate custom inventory allocation request processing templates may be operators of any of the systems shown in FIG. 1 including merchant systems 104, 106, pick system 120, exception handling system 122, restocking system 124 and/or product supplier system 126.

With the generation of one or more custom inventory allocation request processing templates in step 1130 operation proceeds to step 1140. In step 1140 modified versions of the default inventory allocation request processing templates are stored, e.g., in memory 132. The stored inventory allocation templates include information sufficient to determine requests to which they apply, e.g., client and request type information, and/or such information is associated in memory and optionally stored with the templates. Step 1140 includes, in some embodiments, step 1141 which is the step of storing the custom inventory allocation request processing templates. Step 1141 includes in some embodiments step 1142 in which a first modified version of the first default inventory allocation request processing template is stored as a first custom inventory allocation request processing template corresponding to the first client. Step 1141 also includes in some embodiments step 1144 in which a second modified version of the first default inventory allocation request processing template is stored as a second custom inventory allocation request processing template corresponding to the first client.

Operation proceeds from step 1140 via connecting node A 1145 to step 1146 shown in FIG. 11B. In step 1146 the management system 102 receives an inventory allocation request, e.g., order to be processed. The order may be, and sometimes is, from any one of the systems 104, 106, 120, 122, 124, 126 which are coupled to the management system 102 and send requests to the management system 102.

Operation proceeds from step 1146 to step 1148. In step 1148 the management system selects one or more inventory allocation request processing templates to be used in generating a location list to be used in satisfying the received inventory allocation request based one or more of: i) a client from which the inventory allocation request was received, ii) the time the storage location or storage locations being assigned by the inventory allocation are to be used to satisfy an order, e.g., scheduled pick or storage times; and/or iii) the warehouse where the inventory allocation request is to be satisfied. In some embodiments step 1148 includes step 1150. In step 1150 one inventory allocation request processing template is selected from memory for each inventory allocation request line based on a product to which the inventory allocation request line relates. In various embodiments the product to which the request line relates is indicated using a product SKU but in other embodiments other identifiers are used, e.g., text or word identifiers used to uniquely identify products. In some embodiments step 1150 includes step 1151 in which the first customer inventory allocation request processing template is selected based on information indicating the client from which the inventory allocation request was received and further based on a first SKU included in the inventory allocation request for which a template is being selected.

With the inventory allocation request processing template or templates to be used in processing the lines of a received request, e.g., order, in step 1148 operation proceeds to step 1152 wherein one or more storage locations are selected based on a constraint and/or preference indicated in a selected inventory request allocation processing template. In step 1152, a location list to be used in satisfying an order corresponding to the received inventory allocation request is generated. The list includes one or more storage locations from which items on the received inventory allocation request can be picked or stored depending on the type of order. It should be appreciated that in generating the list in step 1152, multiple locations may be, and sometimes are, assigned, e.g., allocated, when a single storage location lacks a sufficient number of items or storage space for the full number of items specified on an inventory allocation request line.

While the location list generated in step 1152 corresponding to an inventory allocation request will include at least one storage location assigned based on an inventory allocation request processing template, in the case where a request corresponds to multiple different items, the list will normally depend on multiple different inventory allocation request processing templates where each of the different templates is selected based on one of the items identified in the received inventory allocation request.

In some embodiments different templates may be, and sometimes are, selected in step 1148 for different lines of an inventory allocation request based on the item specified on the inventory allocation request line corresponding to the item. One or more locations are assigned in step 1152 with at least one item storage location being listed for each of the different items included in an inventory allocation request, e.g., order.

With the location list, e.g., storage location list corresponding to the items to be picked or stored, having been generated in step 1152 operation proceeds to step 1154. In step 1154 the generated location list is communicated to an item pick system 120 or stocking system 124 responsible for implementing the pick or stocking operation corresponding to the received inventory allocation request which then communicates the list to a robotic device, e.g., robotic cart 107 for use in satisfying the order to which the list corresponds. In other embodiments the management system 102 sends the list of locations directly to the robotic device 107. The robotic device 107 uses the list to automatically guide the device between locations in the location list to satisfy an order corresponding to the inventory allocation request for which the location list was generated. The pick or stocking system is then operated in step 1156 to pick items from storage locations on the generated location list or store items in storage locations indicated on the generated location list. The picking may, and sometimes does, involve allocation of robotic pick carts to be used in picking items from the storage locations indicated on the storage location list. The picking or stocking may be implemented using automated robotic devices working alone or in combination with human workers.

Operation proceeds from step 1156 back via connecting node B 1160 to step 1110 to show that the process can be performed on an ongoing basis with inventory allocation request processing templates being easily modified as required by a system operator and inventory allocation requests being processed based on the current set of templates that exist at a given time.

While FIG. 11 shows the process implemented by the system 102 in some embodiments in a flow diagram format, FIG. 12 shows a functional diagram 1220 of an exemplary method implemented in some embodiments.

FIG. 12 is an exemplary functional diagram 1200 showing management system processing of an inventory allocation request 1230 corresponding to an order in accordance with one exemplary embodiment. An inventory allocation request corresponding to an order 1230 is received by the management system 102 and serves as input to the functional processing 1202 performed by the system. The system stored templates 1210 in memory 132 in what is indicated as template storage 1204 which includes per client policy templates 1210.

As part of the processes shown in FIG. 12, the inventory allocation request corresponding to an order 1230 is received as input to the policy implementation component 1206 which may be, and sometimes is, a component of the inventory allocation request processing routine 142. Arrow 1232 is used to represent this input operation.

Inventory allocation goes through the following basic steps. An allocation policy template for the specific client is retrieved, e.g., in the step represented by arrow 1228, from memory. In some embodiments there are policies stored in memory for picking, and stocking, e.g., replenishment. The retrieved policy template is instantiated in step 1214 into a concrete policy using the context of the “line” 1212 being allocated, i.e., the line 1212 including quantity and product identification information. The instantiated policy information is then included with the inventory allocation request in a set of information which also includes information identifying the items for which an allocation is being made and the quantity being allocated. This information is then sent, as represented by arrow 1236 to an inventory application programming interface client (API) 1216. The inventory API 1216 then supplies information on the allocation(s) needed and sends, as represented by arrow 1238, this information to an inventory service component 1208 to identify one or more storage locations to be allocated in response to the received inventory allocation request.

The inventory service component 1208 first looks to identify any existing locations that meet the policy criteria, e.g., the mandatory conditions specified in the template. In some embodiments existing locations are those storage locations already associated with the product for which an allocation is to be made. If any existing locations are found, they are sorted according to the prioritization rules in the policy information. This occurs in find and sort exiting locations step 1218 and results in a ranked list of storage locations to be considered.

If no storage location candidates can be found which can satisfy conditions given the retrieved template, the processing proceeds along the no candidates path 1240 and the quantity is split so that locations which can be used to satisfy smaller quantities can be identified in step 1222. If a split in terms of quantity is implemented, location candidates are found in step 1222 and this information is passed to the allocate step 1224 as indicated by arrow 1250. In step 1224 storage locations are allocated based on the candidate locations and their storage handling capacity, e.g., with allocations being made from the highest ranked list downward with the next best candidate location being used during each iteration. Allocation of storage locations will continue, as represented by looping arrow 1252, in step 1224 in an attempt to satisfy allocation requirements, e.g., identification of sufficient storage locations to satisfy the indicated item quantity. If the item quantity can be satisfied by splitting the order so that it is satisfied using multiple locations, a message is sent to the inventory API client 1216 as represented by arrow 1254 communicating that all requested storage units, e.g., locations, need to satisfy the order have been allocated along with the storage location list. If however allocation step 1224 runs out of candidate storage locations which can be allocated before the item quality specified in the request 1230 is satisfied, operation proceeds, as indicated by arrow 1256, to step 1226, and an error report is generated in step 1226 and communicated along with the allocated storage location list to the inventory API 1216 as represented by arrow 1258.

If in sort step 1218 storage locations which satisfied the conditions of the received request and policy information obtained from the client template were identified that in combination could satisfy any quantity constraints in the template, e.g., minimum portion of total ordered quantity to be provided by a location, the identified locations are ranked in step 1218 and the information, e.g. a ranked list of candidate locations, is communicated, as indicated by arrow 1242, to allocation step, e.g., process, 1220. Allocation step 1220 is similar to allocation step 1224 but will not result in an error since it is used when sufficient candidate storage locations have been found that the request can be satisfied. Allocations are made in step 1220 in the order of best candidate down the list to next best candidate, as represented by looping arrow 1246 until storage locations sufficient to satisfy the quality of items indicated in the received inventory allocation request 1230 have been satisfied. The allocated storage locations are indicated to the inventory API client as represented by arrow 1248.

Inventory API client 1216 communicates the list of allocated storage locations along with any information from the error report 1226 to the system from which the allocation request was received and/or a system e.g., pick or replenishment system, responsible for satisfying the pick or stocking order to which the inventory allocation request 1230 corresponds.

In various embodiments, in a template, any minimum, maximum, or target value can be expressed as a string of the form NN%, where NN is in the form of decimal digits. This is, the number can be any non-negative integer or percentage, including values above 100%. Fractional values are not supported in some embodiments but are permitted in at least some other embodiments.

When a client sends an allocation request to the inventory service, it is doing so in the context of some operation, either adding units to or removing units from a location. The number of units is the value against which the percentages in the template are interpreted in cases where percentages are used in the template to express a quantity related constraint.

When attempting to allocate inventory, whether for picking or putting, the inventory service in some embodiments tries to find a suitable existing location first. It proceeds to look at unused locations when it cannot find a suitable existing location.

An existing location is one that already has an association stored for the given product in that location. There don't have to be any units at the location right now, nor even any planned to be there in the future but an association with the product of the type to which the request relates has been fixed. In this way product can be directed to storage in a given location over time and workers can become familiar with this product and location association.

Criteria for prioritizing existing locations in response to an allocation request can in many cases be considered as lying in a 3-dimensional matrix. In one such embodiment on one axis is the property defining the criteria, on another axis is one of four time values for when that property should be measured, and on the third axis are the constraints for the value of that property at that time.

In various embodiments there are three primary properties which can vary with time. One of the three properties is quantity which is the number of units the system 102 thinks is in a particular storage location. AvailableCapacity is how many units the system thinks could fit into the empty space in the location. A fillFraction can be used to indicate the fraction of the bin volume we think is taken up by assets Thus a fillFraction is a fraction, not a percent, so its normal range is from 0 to 1. Notably, however, in some embodiments a fill Fraction could be expressed in other manners including, potentially, using a percentage or other representation. However expressed, available capacity and/or fill fraction can be and sometimes are used in specifying constraints in templates corresponding to an item.

Capacity is another primary property that can be constrained/targeted, but since it does not depend on the contents of the location, it does not use the “time” axis. Capacity directly has the Min/Max/Target values which can be used to specify preferences or constraints in a storage location allocation request template.

For time-varying properties, there are four logical points in time at which we can evaluate them: i) live—what the system 102 thinks the value of that property is at the time the request is received; ii) afterAllAdds—what the system thinks the value of that property will be after execution of all scheduled adds (scheduled stocking and restocking operations) to the storage location, but no other work; iii) afterAllRemovals—what the system thinks the value of that property will be after all scheduled removals (e.g., picks) from the location, but no other work is performed; and iv) afterAllChanges—what the system thinks the value of that property will be if we execute all scheduled work to the storage location.

For a given property at a given time, the template can set filtering constraint t and/or use it to specify a ranking bias, e.g., preference, when prioritizing among multiple candidates locations.

A picking policy will generally consider the available quantity in an existing location to know if there is enough there to successfully complete the pick.

A replenishment policy will generally consider the availableCapacity in an existing location to know if there is enough room to put the units in that location. A replenishment policy may also consider the quantity or fillFraction to bias which locations should be replenished first.

Picking may favor picking from the fullest bin. Conversely, replenishment operations may favor putting into the emptiest bin. Preference information can be included in the template corresponding to such operations to implement such preferences.

Picking operations might want to target bins that are almost empty, but have just enough left to satisfy the pick to make the bin available for easy stocking. This may help both cycle counting and slotting because empty bins are the fastest to count, and because an empty bin is now free to hold a different product, giving more flexibility to slotting decisions. Weighing against this, however, is that any error in the inventory quantity information produces a greater risk of a short pick. Template preferences can be used to implement such policies.

The time consideration and time axis related preferences or constraints can be a factor in determining the conservatism or optimism of a policy.

For these purposes, a “conservative” policy is one that makes pessimistic assumptions about which other work will get done before it, generally assuming that the currently scheduled work that could interfere with it will happen before it, and any work that could benefit it won't. An “optimistic” policy is naturally the inverse of that, assuming all beneficial work will happen beforehand and no interfering work will. A “middle of the road” policy would assume that all other scheduled work will happen first (both beneficial and interfering).

Note that “conservative”, “optimistic”, etc. are just ways of describing thought patterns around policies. There may not be predetermined rules associated with each of these, and such policies could combine various rules and/or be implemented in various manners if appropriate and useful.

For example, conservative policy can be implemented using the afterAllAdds or afterAllRemoves time point that matches the operation being reserved. For example pick related template can use afterAllRemoves and replenishment related templates can use afterAllAdds to increase the chance of success.

In accordance with the invention, storage allocation decisions can, and sometimes are, based on future time states (e.g. live vs. afterAllAdds vs. afterAllChanges) which allows for conservative/optimistic/middle of the road/hot workflows.

Different types of targets/penalty scoring (min, max, target) can be used for ranking and prioritizing multiple inventory locations.

The storage allocation process can be be re-run at multiple points in time and at different stages of workflow (e.g. at work ingestion, upon being assigned to a chuck for execution, upon encountering an exception in the aisles), to make/confirm decisions as late as possible (based on the state of the world right now, rather than the state of the world when the work was initially ingested) and/or to properly handle exceptions as they arise.

The allocation policies and templates can be extended to take into consideration predicted work—e.g., if a pick (inventory allocation request) has a longer ship date. In addition the storage allocations can take into consideration predicted inventory arrivals that will occur before a ship date associated with an order, which might determine additional inventory locations that could be possibilities for the pick corresponding to a customer order. The methods and apparatus can be useful for allocating storage locations in a wide range of settings including, e.g., both warehouse and retail settings.

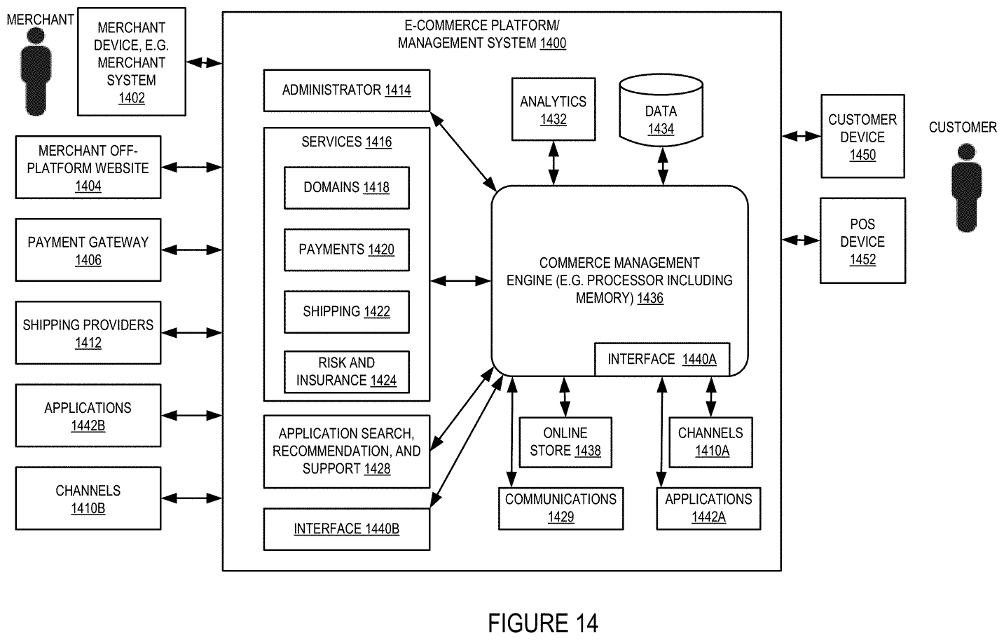

With reference to FIG. 14, an embodiment in which the management system shown in FIG. 1 is implemented as part of an e-commerce platform 1400 that provides merchant products and services to customers. Thus in some embodiments the e-commerce system implements the steps of the method shown in FIG. 11 in addition to performing various other functions. While in some embodiments the management system features and components are incorporated into the E-commerce platform 1400, it should be appreciated that the methods and apparatus described herein are in no way limited to Ecommerce embodiments and can be used in a wide range of applications including, for example, warehouse systems which do not involve or relate to E-commerce.

While the disclosure contemplates using the apparatus, system, and process related to the e-commerce system to purchase products and services, for simplicity the description herein will refer to products. All references to products throughout this disclosure should also be understood to be references to products and/or services, including physical products, digital content, tickets, subscriptions, services to be provided, and the like.

While the disclosure contemplates that a ‘merchant’ and a ‘customer’ may be more than individuals, for simplicity the following description may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 1400 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 1400 for potential use in marketing and selling products, and the like), a service provider user (e.g., a shipping provider 1412, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 1400 may provide a centralized system for providing merchants with online resources and facilities for managing their business. The facilities described herein may be deployed in part or in whole through a machine that executes computer software, modules, program codes, and/or instructions on one or more processors which may be part of or external to the platform 1400. Merchants may utilize the e-commerce platform 1400 for managing commerce with customers, such as by implementing an e-commerce experience with customers through an online store 1438, through channels 1410A-B, through POS devices 1452 in physical locations (e.g., a physical storefront or other location such as through a kiosk, terminal, reader, printer, 3D printer, and the like), by managing their business through the e-commerce platform 1400, and by interacting with customers through a communications facility 1429 of the e-commerce platform 1400, or any combination thereof. A merchant may utilize the e-commerce platform 1400 as a sole commerce presence with customers, or in conjunction with other merchant commerce facilities, such as through a physical store (e.g., ‘brick-and-mortar’ retail stores), a merchant off-platform web site 1404 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 1452 in a physical store of a merchant are linked into the e-commerce platform 1400, where a merchant off-platform website 1404 is tied into the e-commerce platform 1400, such as through ‘buy buttons’ that link content from the merchant off platform website 1404 to the online store 1438, and the like.

The online store 1438 may represent a multitenant facility comprising a plurality of virtual storefronts. In embodiments, merchants may manage one or more storefronts in the online store 1438, such as through a merchant device 1402 (e.g., computer, laptop computer, mobile computing device, and the like), and offer products to customers through a number of different channels 1410A-B (e.g., an online store 1438; a physical storefront through a POS device 1452; electronic marketplace, through an electronic buy button integrated into a website or social media channel such as on a social network, social media page, social media messaging system; and the like). A merchant may sell across channels 1410A-B and then manage their sales through the e-commerce platform 1400, where channels 1410A may be provided internal to the e-commerce platform 1400 or from outside the e-commerce channel 1410B. A merchant may sell in their physical retail store, at pop ups, through wholesale, over the phone, and the like, and then manage their sales through the e-commerce platform 1400. A merchant may employ all or any combination of these, such as maintaining a business through a physical storefront utilizing POS devices 1452, maintaining a virtual storefront through the online store 1438, and utilizing a communication facility 1429 to leverage customer interactions and analytics 1432 to improve the probability of sales. Throughout this disclosure the terms online store 1438 and storefront may be used synonymously to refer to a merchant's online e-commerce offering presence through the e-commerce platform 1400, where an online store 1438 may refer to the multitenant collection of storefronts supported by the e-commerce platform 1400 (e.g., for a plurality of merchants) or to an individual merchant's storefront (e.g., a merchant's online store).

In embodiments, a customer may interact through a customer device 1450 (e.g., computer, laptop computer, mobile computing device, and the like), a POS device 1452 (e.g., retail device, a kiosk, an automated checkout system, and the like), or any other commerce interface device known in the art. The e-commerce platform 1400 may enable merchants to reach customers through the online store 138, through POS devices 1452 in physical locations (e.g., a merchant's storefront or elsewhere), to promote commerce with customers through dialog via electronic communication facility 1429, and the like, providing a system for reaching customers and facilitating merchant services for the real or virtual pathways available for reaching and interacting with customers.

In embodiments, and as described further herein, the e-commerce platform 1400 may be implemented through a processing facility including a processor and a memory, the processing facility storing a set of instructions that, when executed, cause the e-commerce platform 1400 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 1400, merchant devices 1402, payment gateways 1406, application developers, channels 1410A-B, shipping providers 1412, customer devices 1450, point of sale devices 1452, and the like. The e-commerce platform 1400 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In embodiments, elements of the e-commerce platform 1400 may be implemented to operate on various platforms and operating systems, such as iOS, Android, on the web, and the like (e.g., the administrator 1414 being implemented in multiple instances for a given online store for iOS, Android, and for the web, each with similar functionality).

In embodiments, the online store 1438 may be served to a customer device 1450 through a webpage provided by a server of the e-commerce platform 1400. The server may receive a request for the webpage from a browser or other application installed on the customer device 1450, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 1450 and then the template language is replaced by data from the online store 1438, such as when a theme is installed. The template and themes may consider tags, objects, and filters. The client device web browser (or other application) then renders the page accordingly.

In embodiments, online stores 1438 may be served by the e-commerce platform 1400 to customers, where customers can browse and purchase the various products available (e.g., add them to a cart, purchase immediately through a buy-button, and the like). Online stores 1438 may be served to customers in a transparent fashion without customers necessarily being aware that it is being provided through the e-commerce platform 1400 (rather than directly from the merchant). Merchants may use a merchant configurable domain name, a customizable HTML theme, and the like, to customize their online store 1438. Merchants may customize the look and feel of their website through a theme system, such as where merchants can select and change the look and feel of their online store 1438 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 1438, such as through blogs, articles, and the like, as well as configure navigation menus. Merchants may upload images (e.g., for products), video, content, data, and the like to the e-commerce platform 1400, such as for storage by the system (e.g. as data 1434). In embodiments, the e-commerce platform 1400 may provide functions for resizing images, associating an image with a product, adding and associating text with an image, adding an image for a new product variant, protecting images, and the like.

As described herein, the e-commerce platform 1400 may provide merchants with transactional facilities for products through a number of different channels 1410A-B, including the online store 1438, over the telephone, as well as through physical POS devices 1452 as described herein. The e-commerce platform 1400 may include business support services 1416, an administrator 1414, and the like associated with running an on-line business, such as providing a domain service 1418 associated with their online store, payment services 1420 for facilitating transactions with a customer, shipping services 1422 for providing customer shipping options for purchased products, risk and insurance services 1424 associated with product protection and liability, merchant billing, and the like. Services 1416 may be provided via the e-commerce platform 1400 or in association with external facilities, such as through a payment gateway 1406 for payment processing, shipping providers 1412 for expediting the shipment of products, and the like.

In embodiments, the e-commerce platform 1400 may provide for integrated shipping services 1422 (e.g., through an e-commerce platform shipping facility or through a third-party shipping carrier), such as providing merchants with real-time updates, tracking, automatic rate calculation, bulk order preparation, label printing, and the like.

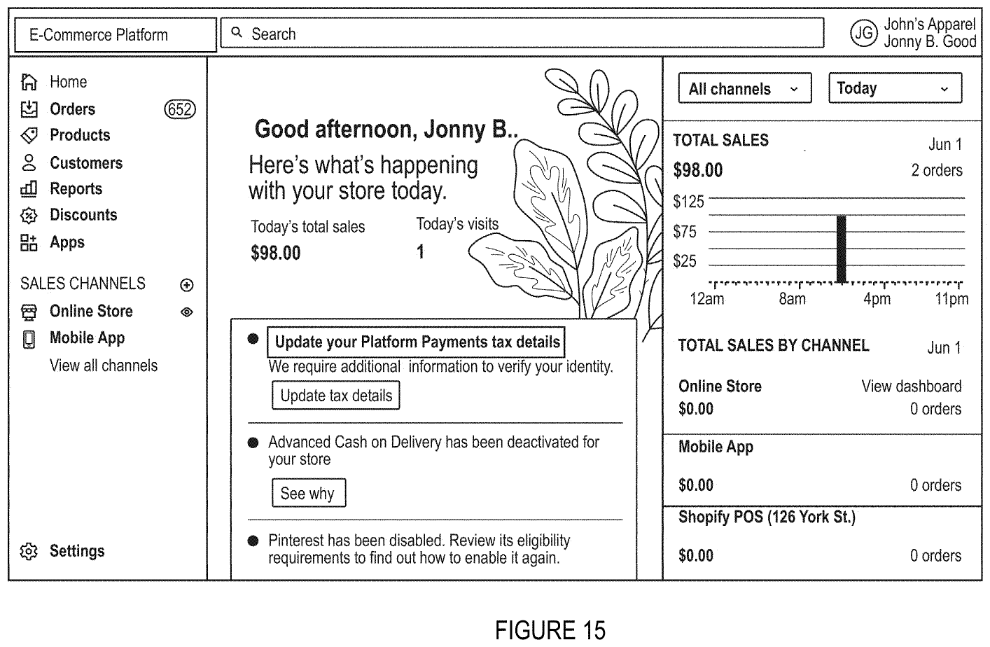

FIG. 15 depicts a non-limiting embodiment for a home page of an administrator 1414, which may show information about daily tasks, a store's recent activity, and the next steps a merchant can take to build their business. In embodiments, a merchant may log in to administrator 1414 via a merchant device 1402 such as from a desktop computer or mobile device, and manage aspects of their online store 1438, such as viewing the online store's 1438 recent activity, updating the online store's 1438 catalog, managing orders, recent visits activity, total orders activity, and the like. In embodiments, the merchant may be able to access the different sections of administrator 1414 by using the sidebar, such as shown on FIG. 15. Sections of the administrator 1414 may include various interfaces for accessing and managing core aspects of a merchant's business, including orders, products, customers, available reports and discounts. The administrator 1414 may also include interfaces for managing sales channels for a store including the online store, mobile application(s) made available to customers for accessing the store (Mobile App), POS devices, and/or a buy button. The administrator 1414 may also include interfaces for managing applications (Apps) installed on the merchant's account; settings applied to a merchant's online store 1438 and account. A merchant may use a search bar to find products, pages, or other information. Depending on the device 1402 or software application the merchant is using, they may be enabled for different functionality through the administrator 1414. For instance, if a merchant logs in to the administrator 1414 from a browser, they may be able to manage all aspects of their online store 1438. If the merchant logs in from their mobile device (e.g. via a mobile application), they may be able to view all or a subset of the aspects of their online store 1438, such as viewing the online store's 1438 recent activity, updating the online store's 1438 catalog, managing orders, and the like.

More detailed information about commerce and visitors to a merchant's online store 1438 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 1410A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 1438, such as based on account status, growth, recent customer activity, and the like. Notifications may be provided to assist a merchant with navigating through a process, such as capturing a payment, marking an order as fulfilled, archiving an order that is complete, and the like.

The e-commerce platform 1400 may provide for a communications facility 1429 and associated merchant interface for providing electronic communications and marketing, such as utilizing an electronic messaging aggregation facility for collecting and analyzing communication interactions between merchants, customers, merchant devices 1402, customer devices 1450, POS devices 1452, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 1429 analyzes the interaction and provides analysis to the merchant on how to improve the probability for a sale.

The e-commerce platform 1400 may provide a financial facility 1420 for secure financial transactions with customers, such as through a secure card server environment. The e-commerce platform 1400 may store credit card information, such as in payment card industry data (PCI) environments (e.g., a card server), to reconcile financials, bill merchants, perform automated clearing house (ACH) transfers between an e-commerce platform 1400 financial institution account and a merchant's bank account (e.g., when using capital), and the like. These systems may have Sarbanes-Oxley Act (SOX) compliance and a high level of diligence required in their development and operation. The financial facility 1420 may also provide merchants with financial support, such as through the lending of capital (e.g., lending funds, cash advances, and the like) and provision of insurance. In addition, the e-commerce platform 1400 may provide for a set of marketing and partner services and control the relationship between the e-commerce platform 1400 and partners. They also may connect and onboard new merchants with the e-commerce platform 1400. These services may enable merchant growth by making it easier for merchants to work across the e-commerce platform 1400. Through these services, merchants may be provided help facilities via the e-commerce platform 1400.

In embodiments, online store 1438 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 1400. In embodiments, the e-commerce platform 1400 may store this data in a data facility 1434. The transactional data may be processed to produce analytics 1432, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 1400 may store information about business and merchant transactions, and the data facility 1434 may have many ways of enhancing, contributing, refining, and extracting data, where over time the collected data may enable improvements to aspects of the e-commerce platform 1400.

Referring again to FIG. 14, in embodiments the e-commerce platform 100 may be configured with a commerce management engine 1436 for content management, task automation and data management to enable support and services to the plurality of online stores 1438 (e.g., related to products, inventory, customers, orders, collaboration, suppliers, reports, financials, risk and fraud, and the like), but be extensible through applications 1442A-B that enable greater flexibility and custom processes required for accommodating an ever-growing variety of merchant online stores, POS devices, products, and services, where applications 1442A may be provided internal to the e-commerce platform 1400 or applications 1442B from outside the e-commerce platform 1400. In embodiments, an application 1442A may be provided by the same party providing the platform 1400 or by a different party. In embodiments, an application 1442B may be provided by the same party providing the platform 1400 or by a different party. The commerce management engine 1436 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 1414 and/or the online store 1438.

The commerce management engine 1436 includes base or “core” functions of the e-commerce platform 1400, and as such, as described herein, not all functions supporting online stores 1438 may be appropriate for inclusion. For instance, functions for inclusion into the commerce management engine 1436 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 1438 (e.g., functions that can be re-used/modified across core functions), limited to the context of a single online store 1438 at a time (e.g., implementing an online store ‘isolation principle’, where code should not be able to interact with multiple online stores 1438 at a time, ensuring that online stores 1438 cannot access each other's data), provide a transactional workload, and the like. Maintaining control of what functions are implemented may enable the commerce management engine 1436 to remain responsive, as many required features are either served directly by the commerce management engine 1436 or enabled through an interface 1440A-B, such as by its extension through an application programming interface (API) connection to applications 1442A-B and channels 1410A-B, where interfaces 140A may be provided to applications 1442A and/or channels 1410A inside the e-commerce platform 1400 or through interfaces 1440B provided to applications 1442B and/or channels 1410B outside the e-commerce platform 100. Generally, the platform 1400 may include interfaces 1440A-B (which may be extensions, connectors, APIs, and the like) which facilitate connections to and communications with other platforms, systems, software, data sources, code and the like. Such interfaces 1440A-B may be an interface 1440A of the commerce management engine 1436 or an interface 1440B of the platform 1400 more generally. If care is not given to restricting functionality in the commerce management engine 1436, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 1436 may be configured to maintain responsiveness, such as through configuration that utilizes timeouts, queues, back-pressure to prevent degradation, and the like.

Although isolating online store data is important to maintaining data privacy between online stores 1438 and merchants, there may be reasons for collecting and using cross-store data, such as for example, with an order risk assessment system or a platform payment facility, both of which require information from multiple online stores 1438 to perform well. In embodiments, rather than violating the isolation principle, it may be preferred to move these components out of the commerce management engine 1436 and into their own infrastructure within the e-commerce platform 1400.

In embodiments, the e-commerce platform 1400 may provide for a platform payment facility 1420, which is another example of a component that utilizes data from the commerce management engine 1436 but may be located outside so as to not violate the isolation principle. The platform payment facility 1420 may allow customers interacting with online stores 1438 to have their payment information stored safely by the commerce management engine 1436 such that they only have to enter it once. When a customer visits a different online store 1438, even if they've never been there before, the platform payment facility 1420 may recall their information to enable a more rapid and correct check out. This may provide a cross-platform network effect, where the e-commerce platform 1400 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 1438. It would be difficult and error prone for each online store 1438 to be able to connect to any other online store 1438 to retrieve the payment information stored there. As a result, the platform payment facility may be implemented external to the commerce management engine 1436.

For those functions that are not included within the commerce management engine 1436, applications 1442A-B provide a way to add features to the e-commerce platform 1400. Applications 1442A-B may be able to access and modify data on a merchant's online store 1438, perform tasks through the administrator 1414, create new flows for a merchant through a user interface (e.g., that is surfaced through extensions/API), and the like. Merchants may be enabled to discover and install applications 1442A-B through application search, recommendations, and support 1428. In embodiments, core products, core extension points, applications, and the administrator 1414 may be developed to work together. For instance, application extension points may be built inside the administrator 1414 so that core features may be extended by way of applications, which may deliver functionality to a merchant through the extension.

In embodiments, applications 1442A-B may deliver functionality to a merchant through the interface 1440A-B, such as where an application 1442A-B is able to surface transaction data to a merchant (e.g., App: “Engine, surface my app data in mobile and web admin using the embedded app SDK”), and/or where the commerce management engine 1436 is able to ask the application to perform work on demand (Engine: “App, give me a local tax calculation for this checkout”).

Applications 1442A-B may support online stores 1438 and channels 1410A-B, provide for merchant support, integrate with other services, and the like. Where the commerce management engine 136 may provide the foundation of services to the online store 1438, the applications 1442A-B may provide a way for merchants to satisfy specific and sometimes unique needs. Different merchants will have different needs, and so may benefit from different applications 1442A-B. Applications 1442A-B may be better discovered through the e-commerce platform 1400 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 1442A-B may be connected to the commerce management engine 1436 through an interface 1440A-B, such as utilizing APIs to expose the functionality and data available through and within the commerce management engine 1436 to the functionality of applications (e.g., through REST, GraphQL, and the like). For instance, the e-commerce platform 1400 may provide API interfaces 1440A-B to merchant and partner-facing products and services, such as including application extensions, process flow services, developer-facing resources, and the like. With customers more frequently using mobile devices for shopping, applications 1442A-B related to mobile use may benefit from more extensive use of APIs to support the related growing commerce traffic. The flexibility offered through use of applications and APIs (e.g., as offered for application development) enable the e-commerce platform 1400 to better accommodate new and unique needs of merchants (and internal developers through internal APIs) without requiring constant change to the commerce management engine 1436, thus providing merchants what they need when they need it. For instance, shipping services 1422 may be integrated with the commerce management engine 1436 through a shipping or carrier service API, thus enabling the e-commerce platform 1400 to provide shipping service functionality without directly impacting code running in the commerce management engine 1436.

Many merchant problems may be solved by letting partners improve and extend merchant workflows through application development, such as problems associated with back-office operations (merchant-facing applications 1442A-B) and in the online store 1438 (customer-facing applications 1442A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 1442A-B, through extension/API 1440A-B, help make products easy to view and purchase in a fast growing marketplace. In embodiments, partners, application developers, internal applications facilities, and the like, may be provided with a software development kit (SDK), such as through creating a frame within the administrator 1414 that sandboxes an application interface. In embodiments, the administrator 1414 may not have control over nor be aware of what happens within the frame. The SDK may be used in conjunction with a user interface kit to produce interfaces that mimic the look and feel of the e-commerce platform 1400, such as acting as an extension of the commerce management engine 1436.

Applications 1442A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 1436, such as for synchronizing a local database, notifying an external integration partner, and the like. Update events may enable this functionality without having to poll the commerce management engine 1436 all the time to check for updates, such as through an update event subscription. In embodiments, when a change related to an update event subscription occurs, the commerce management engine 1436 may post a request, such as to a predefined callback URL. The body of this request may contain a new state of the object and a description of the action or event. Update event subscriptions may be created manually, in the administrator facility 1414, or automatically (e.g., via the API 1440A-B). In embodiments, update events may be queued and processed asynchronously from a state change that triggered them, which may produce an update event notification that is not distributed in real-time.

In embodiments, the e-commerce platform 1400 may provide application search, recommendation and support 1428. Application search, recommendation and support 1428 may include developer products and tools to aid in the development of applications, an application dashboard (e.g., to provide developers with a development interface, to administrators for management of applications, to merchants for customization of applications, and the like), facilities for installing and providing permissions with respect to providing access to an application 1442A-B (e.g., for public access, such as where criteria must be met before being installed, or for private use by a merchant), application searching to make it easy for a merchant to search for applications 1442A-B that satisfy a need for their online store 1438, application recommendations to provide merchants with suggestions on how they can improve the user experience through their online store 1438, a description of core application capabilities within the commerce management engine 1436, and the like. These support facilities may be utilized by application development performed by any entity, including the merchant developing their own application 1442A-B, a third-party developer developing an application 1442A-B (e.g., contracted by a merchant, developed on their own to offer to the public, contracted for use in association with the e-commerce platform 1400, and the like), or an application 1442A or 1442B being developed by internal personal resources associated with the e-commerce platform 1400. In embodiments, applications 1442A-B may be assigned an application identifier (ID), such as for linking to an application (e.g., through an API), searching for an application, making application recommendations, and the like.

The commerce management engine 1436 may include base functions of the e-commerce platform 1400 and expose these functions through APIs 1440A-B to applications 1442A-B. The APIs 1440A-B may enable different types of applications built through application development. Applications 1442A-B may be capable of satisfying a great variety of needs for merchants but may be grouped roughly into three categories: customer-facing applications, merchant-facing applications, integration applications, and the like. Customer-facing applications 1442A-B may include online store 1438 or channels 1410A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 1442A-B may include applications that allow the merchant to administer their online store 1438 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 1412 and payment gateways.

In embodiments, an application developer may use an application proxy to fetch data from an outside location and display it on the page of an online store 1438. Content on these proxy pages may be dynamic, capable of being updated, and the like. Application proxies may be useful for displaying image galleries, statistics, custom forms, and other kinds of dynamic content. The core-application structure of the e-commerce platform 1400 may allow for an increasing number of merchant experiences to be built in applications 1442A-B so that the commerce management engine 1436 can remain focused on the more commonly utilized business logic of commerce.

The e-commerce platform 1400 provides an online shopping experience through a curated system architecture that enables merchants to connect with customers in a flexible and transparent manner. A typical customer experience may be better understood through an embodiment example purchase workflow, where the customer browses the merchant's products on a channel 1410A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 1410A-B. A channel 1410A-B is a place where customers can view and buy products. In embodiments, channels 1410A-B may be modeled as applications 1442A-B (a possible exception being the online store 1438, which is integrated within the commence management engine 1436). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In embodiments, the customer may add what they intend to buy to their cart (in an alternate embodiment, a product may be purchased directly, such as through a buy button as described herein). Customers may add product variants to their shopping cart. The shopping cart model may be channel specific. The online store 1438 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 1400 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 1410A-B may use the commerce management engine 1436 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 1406 may be provided through a card server environment. In embodiments, the payment gateway 1406 may accept international payment, such as integrating with leading international credit card processors. The card server environment may include a card server application, card sink, hosted fields, and the like. This environment may act as the secure gatekeeper of the sensitive credit card information. In embodiments, most of the process may be orchestrated by a payment processing job. The commerce management engine 1436 may support many other payment methods, such as through an offsite payment gateway 1406 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 1410A-B that do not rely on commerce management engine 1436 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 1436 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 1400 may make the merchant aware of compliance issues with respect to legal obligations (e.g., with respect to taxes). In embodiments, the e-commerce platform 1400 may enable merchants to keep track of changes to the contract of sales over time, such as implemented through a sales model component (e.g., an append-only date-based ledger that records sale related events that happened to an item).

Various illustrative, non-limiting numbered exemplary embodiments will now be discussed with reference to the accompanying drawings. Reference numbers included in the exemplary numbered embodiments are intended to facilitate an understanding of the embodiments and are not intended to limit the embodiments to the particular features shown in the figures to which the reference numbers correspond.

### Numbered List of Exemplary Method Embodiments

Method Embodiment 1 A computer-implemented method of processing inventory allocation requests (e.g., inventory allocation requests corresponding to a pick order or a replenishment order), the method comprising: receiving (1146) an inventory allocation request; selecting (1148) one or more inventory allocation request processing templates to be used in generating a location list to be used in satisfying the received inventory allocation request based on one or more of: i) a client from which the inventory allocation request was received (e.g., a shipper who supplies product to a warehouse, a warehouse worker system (such as a picker system) used to control item picking and/or pick completion in the event of an incomplete initial order pick); ii) the time the storage location or storage locations being assigned by the inventory allocation request are to be used to satisfy an order; and iii) the warehouse where the inventory allocation request is to be satisfied; and generating (1152), based on at least one constraint included in a selected inventory allocation request processing template, a location list to be used in satisfying an order corresponding to the received inventory allocation request.

Method Embodiment 2 The computer-implemented method of Method Embodiment 1, further comprising: sending the location list to a robotic device that will travel between the locations in the location list to satisfy the inventory allocation request.

Method Embodiment 3 The computer-implemented method of Method Embodiment 1, wherein selecting (1148) one or more inventory allocation request processing templates to be used in generating a location list includes selecting (1150) one template per inventory allocation request line based on a product (e.g., as indicated by a product Stock Keeping Unit (SKU)) to which the inventory allocation request line relates.

Method Embodiment 4 The computer-implemented method of Method Embodiment 1, wherein the location list indicates one or more locations from which products listed in the inventory allocation request should be picked (assuming it is a purchase order related inventory allocation request) or placed (assuming the inventory allocation request relates to a it is a replenishment or stocking order).

Method Embodiment 5 The computer-implemented method of Method Embodiment 1, further comprising: storing (1110) a plurality of inventory allocation request processing templates in memory, at least some of the inventory allocation request processing templates corresponding to different clients.

Method Embodiment 6 The computer-implemented method of Method Embodiment 5, wherein some of said inventory allocation request processing templates correspond to different times at which locations allocated in response to the inventory allocation request are to be used to satisfy the order to which the inventory allocation request corresponds (e.g., time periods in which the warehouse is operating near maximum operating capacity (e.g., time periods in which restocking and picking are being implemented concurrently) and other time periods where the warehouse is operating a low fraction of maximum capacity (e.g., a period of time when restocking and picking are split into distinct time periods)).

Method Embodiment 7 The computer-implemented method of Method Embodiment 5, wherein said plurality of inventory allocation request processing templates includes a first inventory allocation request processing template, said first inventory allocation request processing template including at least one mandatory constraint that is required to be satisfied for selection of a pick location before the pick location can be included on the location list.

Method Embodiment 8 The computer-implemented method of Method Embodiment 7, wherein said mandatory constraint includes one or more of i) a time constraint which is conditionally applied depending on a time at which the inventory allocation request is to be used to satisfy an order (e.g., different constraints can be set based on whether the inventory allocation request is to be satisfied at a current time, after picks or after replenishment) (in such a case the condition will be applied if the time of order satisfaction matches the time set forth in the constraint); ii) a location fullness constraint (e.g., how full the location should be before or after the pick or replenishment of an inventory allocation request is satisfied) and/or iii) a quantity related constraint that must be satisfied for a location to be available for inclusion on the location list (e.g., a certain percentage of items being available in a location, e.g., 10% of the items of the inventory allocation request).

Method Embodiment 9 The computer-implemented method of Method Embodiment 7, wherein the first inventory allocation request processing template further includes preference information, said preference information being used in selecting between different locations which satisfy mandatory constraints (e.g., the full set of mandatory constraints in the inventory allocation request processing template).

Method Embodiment 10 The computer-implemented method of Method Embodiment 9, wherein said preference information includes a space available after inventory allocation request processing preference (e.g., location near 100% empty to allow for reuse of location for another item).

Method Embodiment 11 The computer-implemented method of Method Embodiment 7, wherein the templates are defined by a text-based object notation (e.g., are implemented as JSON object templates in some but not necessarily all embodiments).

Method Embodiment 12 The computer-implemented method of Method Embodiment 7, further comprising: storing (1112) a default inventory allocation request processing template for a first product (e.g., a product identified by a first Stock Keeping Unit(SKU)); providing (1132) a first client (e.g., a warehouse operator, incoming inventory allocation request system operator, replenishment system operator, or other system or operator) a first opportunity to modify a first default inventory allocation request processing template to include a customized constraint or preference; and storing (1142) a first modified version of the first default inventory allocation request processing template as a first custom inventory allocation request processing template corresponding to the first client.

Method Embodiment 13 The computer-implemented method of Method Embodiment 12, wherein the first modified version of the first default inventory allocation request processing template includes more constraints or preferences than the default inventory allocation request processing template for the first product.

Method Embodiment 14 The computer-implemented method of Method Embodiment 13, wherein the first modified version of the first default inventory allocation request processing template includes one or more of: i) a time constraint (e.g., a condition based on a time specified relative to completion of one or more actions such as picks, replenishment or scheduled product delivery), ii) a storage location fullness constraint (e.g., that the location be below or above a specified fullness level before or after inventory allocation request satisfaction), or iii) an inventory allocation request portion constraint that was not included in the default inventory allocation request processing template.

Method Embodiment 15 The computer-implemented method of Method Embodiment 13, wherein the first modified version of the first default inventory allocation request processing template includes historical storage location preference based information indicating a preference for storing the first product in a location which was previously used to store the first product.

Method Embodiment 16 The computer-implemented method of Method Embodiment 12, wherein said received inventory allocation request is from said first client and includes a first inventory allocation request line specifying a first SKU used as an identifier of a product to which the first inventory allocation request line relates and a quantity corresponding to the first SKU; and wherein selecting (1148) one or more an inventory allocation request processing templates to be used in generating a location list to be used in satisfying the inventory allocation request includes selecting (1151) the first custom inventory allocation request processing template based on a template corresponding to the client (e.g., stocking, replenishment, pick or merchant system) from which the inventory allocation request was received and further based on first SKU included in the inventory allocation request.

Method Embodiment 17 The computer-implemented method of Method Embodiment 12, further comprising: providing (1134) the first client (e.g., a warehouse operator, replenishment system operator, or other system operator, e.g. pick cart system operator) a second opportunity to modify the first default inventory allocation request processing template to include another customized constraint or preference; and storing (1144) a second modified version of the first default inventory allocation request processing template as a second custom inventory allocation request processing template corresponding to the first client.

Method Embodiment 18 The computer-implemented method of Method Embodiment 17, wherein the first custom inventory allocation request processing template corresponds to a first period of time in which the first warehouse operates at a first level of inventory allocation request processing capacity (e.g., below 70%) and wherein the second customer inventory allocation request processing template corresponds to a second period of time in which the first warehouse operates at a second level of inventory allocation request processing capacity (e.g., at or above 70% inventory allocation request processing capacity).

### Numbered List of Exemplary System Embodiments

System Embodiment 1 A system (100) for processing inventory allocation requests (e.g., inventory allocation requests corresponding to a pick order or a replenishment order), the system comprising: memory (132) storing inventory allocation request processing templates (144); and a processor (130) configured to control the system to: receive (1146) an inventory allocation request; select (1148) one or more inventory allocation request processing templates to be used in generating a location list to be used in satisfying the received inventory allocation request based on one or more of: i) a client from which the inventory allocation request was received (e.g., a shipper who supplies product to a warehouse, a warehouse worker system (such as a picker system) used to control item picking and/or pick completion in the event of an incomplete initial order pick); ii) the time the storage location or storage locations being assigned by the inventory allocation request are to be used to satisfy an order; and iii) the warehouse where the inventory allocation request is to be satisfied; and generate (1152), based on at least one constraint included in a selected inventory allocation request processing template, a location list to be used in satisfying an order corresponding to the received inventory allocation request.

System Embodiment 2 The system (100) of System Embodiment 1, further comprising: a robotic device (107); and wherein the processor (130) is further configured to control a transmitter (138) to send the location list to a robotic device that will travel between the locations in the location list to satisfy the inventory allocation request.

System Embodiment 3 The system (100) of System Embodiment 1, wherein the processor (130) is configured to select (1150) one template per inventory allocation request line based on a product (e.g., as indicated by a product Stock Keeping Unit (SKU)) to which the inventory allocation request line relates as part of selecting (1148) one or more inventory allocation request processing templates to be used in generating a location list includes.

System Embodiment 4 The system (100) of System Embodiment 1, wherein the location list indicates one or more locations from which products listed in the inventory allocation request should be picked (assuming it is a purchase order related inventory allocation request) or placed (assuming the inventory allocation request relates to a it is a replenishment or stocking order).

System Embodiment 5 The system (100) of System Embodiment 1, wherein the stored inventory allocation request processing templates (144) include at least some of the inventory allocation request processing templates corresponding to different clients.

System Embodiment 6 The system (100) of System Embodiment 5, wherein some of said stored inventory allocation request processing templates correspond to different times at which locations allocated in response to the inventory allocation request are to be used to satisfy the order to which the inventory allocation request corresponds (e.g., time periods in which the warehouse is operating near maximum operating capacity (e.g., time periods in which restocking and picking are being implemented concurrently) and other time periods where the warehouse is operating a low fraction of maximum capacity (e.g., a period of time when restocking and picking are split into distinct time periods)).

System Embodiment 7 The system (100) of System Embodiment 5, wherein said stored inventory allocation request processing templates includes a first inventory allocation request processing template, said first inventory allocation request processing template including at least one mandatory constraint that is required to be satisfied for selection of a pick location before the pick location can be included on the location list.

System Embodiment 8 The system (100) of System Embodiment 7, wherein said mandatory constraint includes one or more of i) a time constraint which is conditionally applied depending on a time at which the inventory allocation request is to be used to satisfy an order (e.g., different constraints can be set based on whether the inventory allocation request is to be satisfied at a current time, after picks or after replenishment) (in such a case the condition will be applied if the time of order satisfaction matches the time set forth in the constraint); ii) a location fullness constraint (e.g., how full the location should be before or after the pick or replenishment of an inventory allocation request is satisfied) and/or iii) a quantity related constraint that must be satisfied for a location to be available for inclusion on the location list (e.g., a certain percentage of items being available in a location, e.g., 10% of the items of the inventory allocation request).

System Embodiment 9 The system (100) of System Embodiment 7, wherein the first inventory allocation request processing template further includes preference information, said preference information being used in selecting between different locations which satisfy mandatory constraints (e.g., the full set of mandatory constraints in the inventory allocation request processing template).

System Embodiment 10 The system (100) of System Embodiment 9, wherein said preference information includes a space available after inventory allocation request processing preference (e.g., location near 100% empty to allow for reuse of location for another item).

System Embodiment 11 The system (100) of System Embodiment 7, wherein the inventory allocation request processing templates are defined by a text-based object notation (e.g., are implemented as JSON object templates in some but not necessarily all embodiments).

System Embodiment 12 The system (100) of System Embodiment 1, wherein the processor (130) is further configured to control the system to: store (1112) a default inventory allocation request processing template (140) for a first product (e.g., a product identified by a first Stock Keeping Unit(SKU)); provide (1132) a first client (e.g., a warehouse operator, incoming inventory allocation request system operator, replenishment system operator, or other system or operator) a first opportunity to modify the first default inventory allocation request processing template to include a customized constraint or preference; and store (1142) a first modified version of the first default inventory allocation request processing template as a first custom inventory allocation request processing template (147) corresponding to the first client.

System Embodiment 13 The system (100) of System Embodiment 12, wherein the first modified version of the first default inventory allocation request processing template includes more constraints or preferences than the default inventory allocation request processing template for the first product.

System Embodiment 14 The system (100) of System Embodiment 13, wherein the first modified version of the first default inventory allocation request processing template includes one or more of: i) a time constraint (e.g., a condition based on a time specified relative to completion of one or more actions such as picks, replenishment or scheduled product delivery), ii) a storage location fullness constraint (e.g., that the location be below or above a specified fullness level before or after inventory allocation request satisfaction), or iii) an inventory allocation request portion constraint that was not included in the default inventory allocation request processing template.

System Embodiment 15 The system (100) of System Embodiment 13, wherein the first modified version of the first default inventory allocation request processing template includes historical storage location preference based information indicating a preference for storing the first product in a location which was previously used to store the first product.

System Embodiment 16 The system (100) of System Embodiment 12, wherein said received inventory allocation request is from said first client and includes a first inventory allocation request line specifying a first SKU used as an identifier of a product to which the first inventory allocation request line relates and a quantity corresponding to the first SKU; and wherein the processor (130) is further configured to control the system to select (1151) the first custom inventory allocation request processing template based on a template corresponding to the client (e.g., stocking, replenishment, pick or merchant system) from which the inventory allocation request was received and further based on first SKU included in the received inventory allocation request as part of selecting (1148) one or more an inventory allocation request processing templates to be used in generating a location list to be used in satisfying the inventory allocation request includes.

System Embodiment 17 The system (100) of System Embodiment 12, wherein the processor is further configured to control the system to: provide (1134) the first client (e.g., a warehouse operator, replenishment system operator, or other system operator, e.g. pick cart system operator) a second opportunity to modify the first default inventory allocation request processing template to include another customized constraint or preference; and store (1144) a second modified version of the first default inventory allocation request processing template as a second custom inventory allocation request processing template corresponding to the first client.

System Embodiment 18 The system (100) of System Embodiment 17, wherein the first custom inventory allocation request processing template corresponds to a first period of time in which the first warehouse operates at a first level of inventory allocation request processing capacity (e.g., below 70%) and wherein the second customer inventory allocation request processing template corresponds to a second period of time in which the first warehouse operates at a second level of inventory allocation request processing capacity (e.g., at or above 70% inventory allocation request processing capacity).

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere.

The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g. Long Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

What is claimed is:

1. A computer-implemented method of processing inventory allocation requests, the method comprising:
receiving an inventory allocation request;
selecting one or more inventory allocation request processing templates to be used in generating a location list to be used in satisfying the received inventory allocation request based on one or more of: i) a client from which the inventory allocation request was received; ii) the time the storage location or storage locations being assigned by the inventory allocation request are to be used to satisfy an order; and iii) the warehouse where the inventory allocation request is to be satisfied; and
generating, based on at least one constraint included in a selected inventory allocation request processing template, a location list to be used in satisfying an order corresponding to the received inventory allocation request.

2. The computer-implemented method of claim 1, further comprising:
sending the location list to a robotic device that will travel between the locations in the location list to satisfy the inventory allocation request.

3. The computer-implemented method of claim 1, further comprising:
storing a plurality of inventory allocation request processing templates in memory, at least some of the inventory allocation request processing templates corresponding to different clients.

4. The computer-implemented method of claim 1, wherein some of said inventory allocation request processing templates correspond to different times at which locations allocated in response to the inventory allocation request are to be used to satisfy the order to which the inventory allocation request corresponds.

5. The computer-implemented method of claim 3, wherein said plurality of inventory allocation request processing templates includes a first inventory allocation request processing template, said first inventory allocation request processing template including at least one mandatory constraint that is required to be satisfied for selection of a pick location before the pick location can be included on the location list.

6. The computer-implemented method of claim 5, wherein said mandatory constraint includes one or more of i) a time constraint which is conditionally applied depending on a time at which the inventory allocation request is to be used to satisfy an order; ii) a location fullness constraint and/or iii) a quantity related constraint that must be satisfied for a location to be available for inclusion on the location list.

7. The computer-implemented method of claim 5, wherein the first inventory allocation request processing template further includes preference information, said preference information being used in selecting between different locations which satisfy mandatory constraints.

8. The computer-implemented method of claim 6, wherein said preference information includes a space available after inventory allocation request processing preference.

9. The computer-implemented method of claim 5, wherein the inventory allocation request processing templates are defined by a text-based object notation.

10. The computer-implemented method of claim 5, further comprising:
storing a default inventory allocation request processing template for a first product;
providing a first client a first opportunity to modify a first default inventory allocation request processing template to include a customized constraint or preference; and
storing a first modified version of the first default inventory allocation request processing template as a first custom inventory allocation request processing template corresponding to the first client.

11. The computer-implemented method of claim 10,
wherein said received inventory allocation request is from said first client and includes a first inventory allocation request line specifying a first SKU used as an identifier of a product to which the first inventory allocation request line relates and a quantity corresponding to the first SKU; and
wherein selecting one or more an inventory allocation request processing templates to be used in generating a location list to be used in satisfying the inventory allocation request includes selecting the first custom inventory allocation request processing template based on a template corresponding to the client from which the inventory allocation request was received and further based on first SKU included in the inventory allocation request.

12. The computer-implemented method of claim 10, further comprising:
providing the first client a second opportunity to modify the first default inventory allocation request processing template to include another customized constraint or preference; and
storing a second modified version of the first default inventory allocation request processing template as a second custom inventory allocation request processing template corresponding to the first client.

13. The computer-implemented method of claim 12, wherein the first custom inventory allocation request processing template corresponds to a first period of time in which the first warehouse operates at a first level of inventory allocation request processing capacity and wherein the second customer inventory allocation request processing template corresponds to a second period of time in which the first warehouse operates at a second level of inventory allocation request processing capacity.

14. A system for processing inventory allocation requests, the system comprising:
memory storing inventory allocation request processing templates; and
a processor configured to control the system to:
receive an inventory allocation request;
select one or more inventory allocation request processing templates to be used in generating a location list to be used in satisfying the received inventory allocation request based on one or more of: i) a client from which the inventory allocation request was received; ii) the time the storage location or storage locations being assigned by the inventory allocation request are to be used to satisfy an order; and iii) the warehouse where the inventory allocation request is to be satisfied; and
generate, based on at least one constraint included in a selected inventory allocation request processing template, a location list to be used in satisfying an order corresponding to the received inventory allocation request.

15. The system of claim 14, further comprising:
a robotic device; and
wherein the processor is further configured to control a transmitter to send the location list to a robotic device that will travel between the locations in the location list to satisfy the inventory allocation request.

16. The system of claim 14, wherein the stored inventory allocation request processing templates include at least some of the inventory allocation request processing templates corresponding to different clients.

17. The system of claim 16, wherein some of said stored inventory allocation request processing templates correspond to different times at which locations allocated in response to the inventory allocation request are to be used to satisfy the order to which the inventory allocation request corresponds.

18. The system of claim 16, wherein said stored inventory allocation request processing templates includes a first inventory allocation request processing template, said first inventory allocation request processing template including at least one mandatory constraint that is required to be satisfied for selection of a pick location before the pick location can be included on the location list.

19. The system of claim 18, wherein said mandatory constraint includes one or more of i) a time constraint which is conditionally applied depending on a time at which the inventory allocation request is to be used to satisfy an order; ii) a location fullness constraint and/or iii) a quantity related constraint that must be satisfied for a location to be available for inclusion on the location list.

20. The system of claim 18, wherein the first inventory allocation request processing template further includes preference information, said preference information being used in selecting between different locations which satisfy mandatory constraints.

21. The system of claim 20, wherein said preference information includes a space available after inventory allocation request processing preference.

22. The system of claim 18, wherein the inventory allocation request processing templates are defined by a text-based object notation.

23. The system of claim 14, wherein the processor is further configured to control the system to:
store a default inventory allocation request processing template for a first product;
provide a first client a first opportunity to modify the first default inventory allocation request processing template to include a customized constraint or preference; and
store a first modified version of the first default inventory allocation request processing template as a first custom inventory allocation request processing template corresponding to the first client.

24. The system of claim 23,
wherein said received inventory allocation request is from said first client and includes a first inventory allocation request line specifying a first SKU used as an identifier of a product to which the first inventory allocation request line relates and a quantity corresponding to the first SKU; and
wherein the processor is further configured to control the system to select the first custom inventory allocation request processing template based on a template corresponding to the client from which the inventory allocation request was received and further based on first SKU included in the received inventory allocation request as part of selecting one or more an inventory allocation request processing templates to be used in generating a location list to be used in satisfying the inventory allocation request includes.

25. The system of claim 23, wherein the processor is further configured to control the system to:
provide the first client a second opportunity to modify the first default inventory allocation request processing template to include another customized constraint or preference; and
store a second modified version of the first default inventory allocation request processing template as a second custom inventory allocation request processing template corresponding to the first client.

26. The system of claim 25, wherein the first custom inventory allocation request processing template corresponds to a first period of time in which the first warehouse operates at a first level of inventory allocation request processing capacity and wherein the second customer inventory allocation request processing template corresponds to a second period of time in which the first warehouse operates at a second level of inventory allocation request processing capacity.

27. A non-transitory computer readable medium including processor executable instructions which when executed by a processor of a system control the system to:
receive an inventory allocation request;
select one or more inventory allocation request processing templates to be used in generating a location list to be used in satisfying the received inventory allocation request based on one or more of: i) a client from which the inventory allocation request was received; ii) the time the storage location or storage locations being assigned by the inventory allocation request are to be used to satisfy an order; and iii) the warehouse where the inventory allocation request is to be satisfied; and
generate, based on at least one constraint included in a selected inventory allocation request processing template, a location list to be used in satisfying an order corresponding to the received inventory allocation request.
